(19) United States
(12) Patent Application Publication
(10) Pub. No.: US 2025/0381774 A1
(43) Pub. Date: Dec. 18, 2025

(54) Liquid Ejecting Apparatus And Head Unit

(71) Applicant: SEIKO EPSON CORPORATION, Tokyo (JP)

(72) Inventor: Shunsuke KASAI, Minowa (JP)

(21) Appl. No.: 19/236,097

(22) Filed: Jun. 12, 2025

(30) Foreign Application Priority Data
Jun. 13, 2024 (JP) 2024-096074

(51) Int. Cl. B41J 2/045; B41J 2/14

(52) U.S. Cl. CPC B41J 2/04563; B41J 2/0455; B41J 2/04581; B41J 2/04588; B41J 2/14233

(57) ABSTRACT

A liquid ejecting apparatus includes: a print head including a vibration plate, a pressure chamber, a nozzle from which the liquid is ejected, and a temperature detecting section that outputs a head temperature signal corresponding to a temperature of the pressure chamber; a temperature information output circuit that outputs a temperature information signal corresponding to the head temperature signal acquired at predetermined sampling periods and holds a plurality of pieces of temperature information obtained by acquiring the head temperature signal at each of the sampling periods; and a processor that determines the number of samples of the pieces of temperature information to be used to generate the temperature information signal, based on an adjustment temperature information group including the plurality of pieces of temperature information. The number of samples determined by the processor is stored in the temperature information output circuit.

The present application is based on, and claims priority from JP Application Serial Number 2024-096074, filed Jun. 13, 2024, the disclosure of which is hereby incorporated by reference herein in its entirety.

### BACKGROUND

### 1. Technical Field

The present disclosure relates to a liquid ejecting apparatus and a head unit.

### 2. Related Art

A configuration in which a print head including a piezoelectric element, a pressure chamber, and a nozzle communicating with the pressure chamber is disposed in a liquid ejecting apparatus is known. The print head ejects, from the nozzle, liquid supplied to the pressure chamber by driving the piezoelectric element to change the volume of the pressure chamber. For a liquid ejecting apparatus including such a print head, there is known a technique for implementing ejection control suitable for the temperature of ink by controlling the driving of a piezoelectric element based on the temperature of the ink stored in the print head.

For example, JP-A-2024-051474 discloses a technique in which the temperature of a print head is detected by a temperature detector disposed in the print head and the driving of a piezoelectric element is controlled based on the detected temperature of the print head.

However, in the technique described in JP-A-2024-051474, there is room for improvement from the viewpoint of accurately detecting the temperature of the print head.

### SUMMARY

According to an aspect of the present disclosure, a liquid ejecting apparatus includes a drive circuit that outputs a drive signal, a print head that receives the drive signal and ejects liquid in response to the drive signal, a temperature information output circuit that acquires a head temperature signal corresponding to a temperature of the print head at predetermined sampling periods and outputs a temperature information signal corresponding to the acquired head temperature signal, and a processor that controls the print head and the drive circuit. The print head includes a piezoelectric element that includes a first electrode, a second electrode, and a piezoelectric body located between the first electrode and the second electrode in a stacking direction in which the first electrode, the second electrode, and the piezoelectric body are stacked, and that receives the drive signal and is driven in response to the drive signal, a vibration plate that is located on one side of the piezoelectric element in the stacking direction and is deformed by the driving of the piezoelectric element, a pressure chamber substrate that is located on one side of the vibration plate in the stacking direction and is provided with a pressure chamber in which the liquid is stored and that changes in volume due to the deformation of the vibration plate, a nozzle from which the liquid is ejected in accordance with the change in the volume of the pressure chamber, and a temperature detecting section that is located on the other side of the vibration plate in the stacking direction and outputs the head temperature signal corresponding to a temperature of the pressure chamber. The temperature information output circuit holds a plurality of pieces of temperature information obtained by acquiring the head temperature signal at each of the sampling periods. The processor acquires, as an adjustment temperature information group, the plurality of pieces of temperature information held in the temperature information output circuit and determines, based on the acquired adjustment temperature information group, a number of samples of the pieces of temperature information to be used to generate the temperature information signal. The number of samples determined by the processor is stored in the temperature information output circuit.

According to another aspect of the present disclosure, a head unit includes a print head that receives a drive signal and ejects liquid in response to the drive signal, and a temperature information output circuit that acquires a head temperature signal corresponding to a temperature of the print head at predetermined sampling periods and outputs a temperature information signal corresponding to the acquired head temperature signal. The print head includes a piezoelectric element that includes a first electrode, a second electrode, and a piezoelectric body located between the first electrode and the second electrode in a stacking direction in which the first electrode, the second electrode, and the piezoelectric body are stacked, and that receives the drive signal and is driven in response to the drive signal, a vibration plate that is located on one side of the piezoelectric element in the stacking direction and is deformed by the driving of the piezoelectric element, a pressure chamber substrate that is located on one side of the vibration plate in the stacking direction and is provided with a pressure chamber in which the liquid is stored and that changes in volume due to the deformation of the vibration plate, a nozzle from which the liquid is ejected in accordance with the change in the volume of the pressure chamber, and a temperature detecting section that is located on the other side of the vibration plate in the stacking direction and outputs the head temperature signal corresponding to a temperature of the pressure chamber. The temperature information output circuit stores a number of samples determined based on a plurality of pieces of temperature information obtained by acquiring the head temperature signal at each of the sampling periods.

### BRIEF DESCRIPTION OF THE DRAWINGS

FIG. 1 is a diagram illustrating a schematic configuration of a liquid ejecting apparatus.

FIG. 2 is an exploded perspective view illustrating a structure of a print head.

FIG. 3 is a plan view of the print head as viewed in a direction along a Z axis.

FIG. 4 is a cross-sectional view of the print head taken along line IV-IV illustrated in FIG. 3.

FIG. 5 is a detailed view of a main section illustrated in FIG. 4.

FIG. 6 is a cross-sectional view of the print head taken along line VI-VI illustrated in FIG. 3.

FIG. 7 is a diagram illustrating a functional configuration of the liquid ejecting apparatus.

FIG. 8 is a diagram illustrating an example of a signal waveform of a drive signal.

FIG. 9 is a diagram illustrating a configuration of a drive signal selection circuit.

FIG. 10 is a diagram illustrating an example of the content of decoding by decoders.

FIG. 11 is a diagram illustrating a configuration of a selection circuit.

FIG. 12 is a diagram for explaining an operation of the drive signal selection circuit.

FIG. 13 is a diagram illustrating an example of a configuration of a temperature detection circuit.

FIG. 14 is a diagram illustrating an example of a configuration of a temperature information output circuit.

FIG. 15 is a diagram illustrating an example of a configuration of a shift register.

FIG. 16 is a diagram illustrating an example of the timing of acquiring the temperature of the print head.

FIG. 17 is a diagram illustrating an example of a method of determining the optimum number of samples of pieces of held temperature information and a method of acquiring the temperature of each print head based on the number of samples.

FIG. 18 is a diagram illustrating an example of a process of determining the number of samples.

FIG. 19 is a diagram illustrating an example of a process of acquiring pieces of temperature information.

### DESCRIPTION OF EMBODIMENTS

Hereinafter, preferred embodiments of the present disclosure will be described with reference to the drawings. The drawings to be used are for convenience of description. Note that the embodiments described below do not unduly limit the contents described in the appended claims. In addition, all of configurations described below are not necessarily essential components of the present disclosure.

### 1. Schematic Configuration of Liquid Ejecting Apparatus

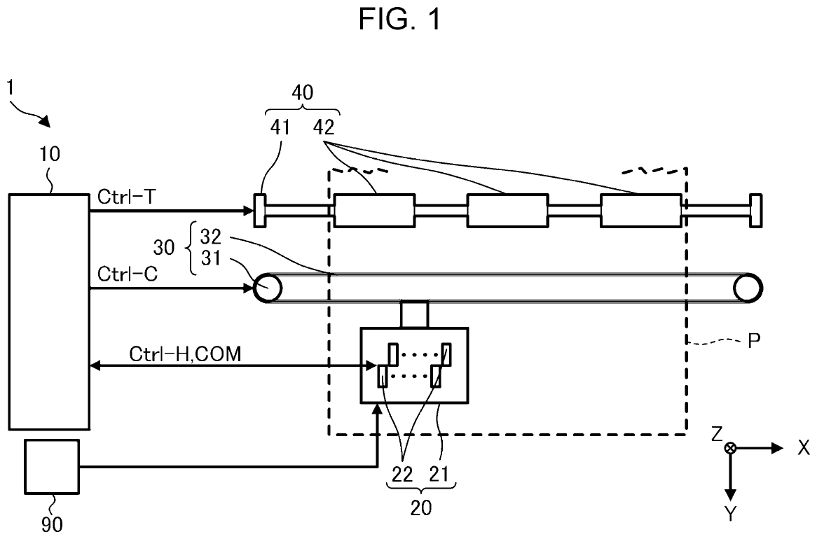

FIG. 1 is a diagram illustrating a schematic configuration of a liquid ejecting apparatus 1. The liquid ejecting apparatus 1 according to the present embodiment is a so-called serial printing type ink jet printer that causes a carriage 21 on which print heads 22 that eject ink as an example of liquid are mounted to reciprocate along a scanning axis, and ejects ink onto a medium P transported in a transport direction, thereby forming a desired image on the medium P. In addition, as the medium P used in the liquid ejecting apparatus 1, an arbitrary printing target such as printing paper, a resin film, or a fabric can be used. The liquid ejecting apparatus 1 is not limited to a serial printing type ink jet printer, and may be a line printing type ink jet printer. The liquid ejecting apparatus 1 is not limited to an ink jet printer, and may be a color material ejecting apparatus that is used for manufacturing a color filter of a liquid crystal display or the like, an electrode material ejecting apparatus that is used for forming an electrode of an organic EL display, a field emission display (FED), or the like, a bio-organic material ejecting apparatus that is used for manufacturing a biochip, a three-dimensional shaping apparatus, a textile printing apparatus, or the like.

In the following description, an X axis, a Y axis, and a Z axis, which are three spatial axes orthogonal to each other, are used. In the following description, when directions along the X axis, the Y axis, and the Z axis are specified, a tip end side of an arrow indicating the direction along the X axis is referred to as +X side, a starting end side of the arrow indicating the direction along the X axis is referred to as −X side, a tip end side of an arrow indicating the direction along the Y axis is referred to as +Y side, a starting end side of the arrow indicating the direction along the Y axis is referred to as −Y side, a tip end side of an arrow indicating the direction along the Z axis is referred to as +Z side, and a starting end side of the arrow indicating the direction along the Z axis is referred to as −Z side.

As illustrated in FIG. 1, the liquid ejecting apparatus 1 includes a control unit 10, a head unit 20, a moving unit 30, a transport unit 40, and an ink container 90.

In the ink container 90, a plurality of types of ink to be ejected onto the medium P are stored. As the ink container 90 in which the ink is stored, an ink cartridge, a bag-shaped ink pack formed of a flexible film, an ink tank which can be replenished with ink, or the like can be used.

The control unit 10 includes a processing circuit such as a central processing unit (CPU) or a field programmable gate array (FPGA) and a storage circuit such as a semiconductor memory, and controls each component of the liquid ejecting apparatus 1 including the head unit 20.

The head unit 20 includes the carriage 21 and the plurality of print heads 22. The carriage 21 is fixed to an endless belt 32 included in the moving unit 30 to be described later. The plurality of print heads 22 are mounted on the carriage 21. In addition, a control signal Ctrl-H and a drive signal COM are output by the control unit 10 and input to each of the plurality of print heads 22. Further, the ink stored in the ink container 90 is supplied to each of the plurality of print heads 22 via a tube or the like (not illustrated). The print heads 22 eject the ink supplied from the ink container 90 based on the control signal Ctrl-H and the drive signal COM input to the print heads 22. In this case, a direction that is from the −Z side to the +Z side along the Z axis and in which the print heads 22 eject the ink may be referred to as an ejection direction.

The moving unit 30 includes a carriage motor 31 and the endless belt 32. The carriage motor 31 operates based on a control signal Ctrl-C input from the control unit 10. The endless belt 32 extends in the direction along the X axis and rotates in accordance with the operation of the carriage motor 31. Accordingly, the carriage 21 fixed to the endless belt 32 moves along the X axis. That is, the moving unit 30 causes the plurality of print heads 22 mounted on the carriage 21 to reciprocate along the X axis. In the following description, the direction along the X axis in which the plurality of print heads 22 mounted on the carriage 21 move may be referred to as a scanning direction.

The transport unit 40 includes a transport motor 41 and a transport roller 42. The transport motor 41 operates based on a control signal Ctrl-T input from the control unit 10. The transport roller 42 rotates in accordance with the operation of the transport motor 41 in a state where the medium P is held by the transport roller 42. Accordingly, the medium P held by the transport roller 42 is transported from the −Y side toward the +Y side along the Y axis. That is, the transport unit 40 transports the medium P from the −Y side toward the +Y side along the Y axis. In the following description, a direction that is from the −Y side toward the +Y side and in which the medium P is transported may be referred to as a transport direction.

In the liquid ejecting apparatus 1 configured as described above, the moving unit 30 controls the reciprocating movement of the carriage 21 in the scanning direction, and the transport unit 40 controls the transport of the medium P in the transport direction. The print heads 22 mounted on the carriage 21 eject the ink in conjunction with the reciprocation of the carriage 21 in the scanning direction and the transport of the medium P in the transport direction. As a result, the ink ejected from the print heads 22 can land on any portion on a front surface of the medium P, and a desired image is formed on the medium P.

### 2. Schematic Structure of Each Print Head

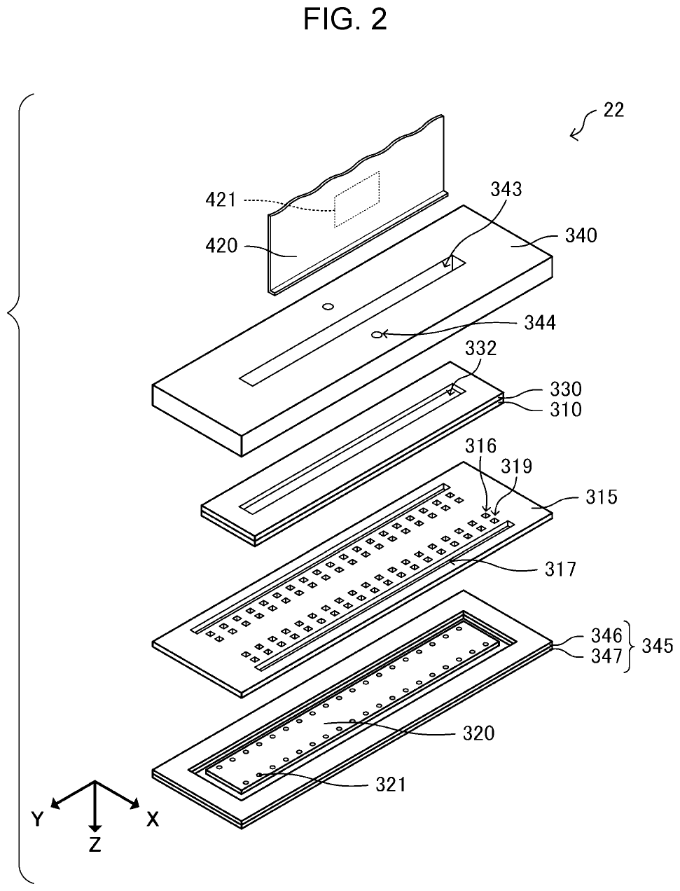

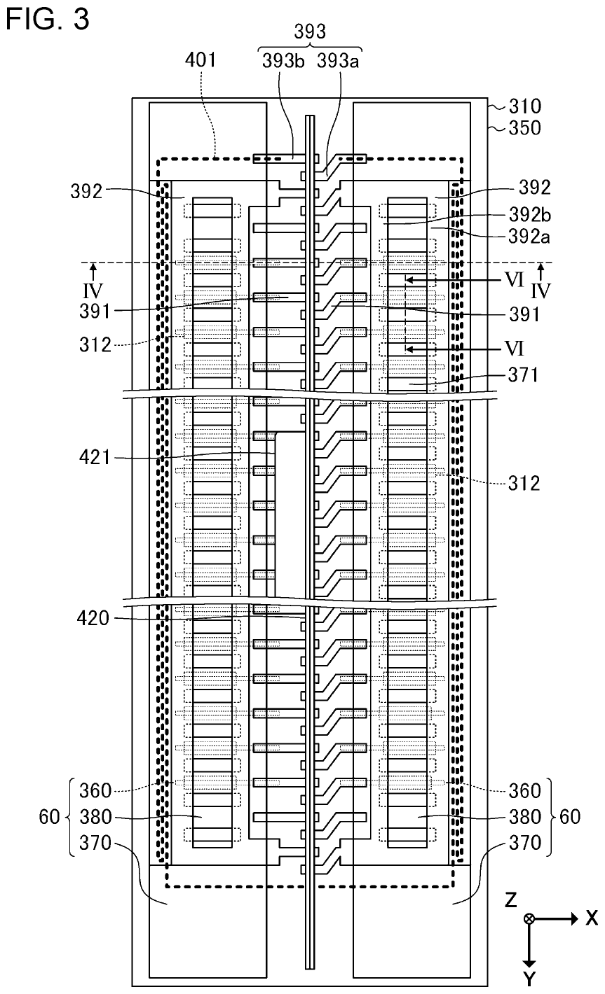

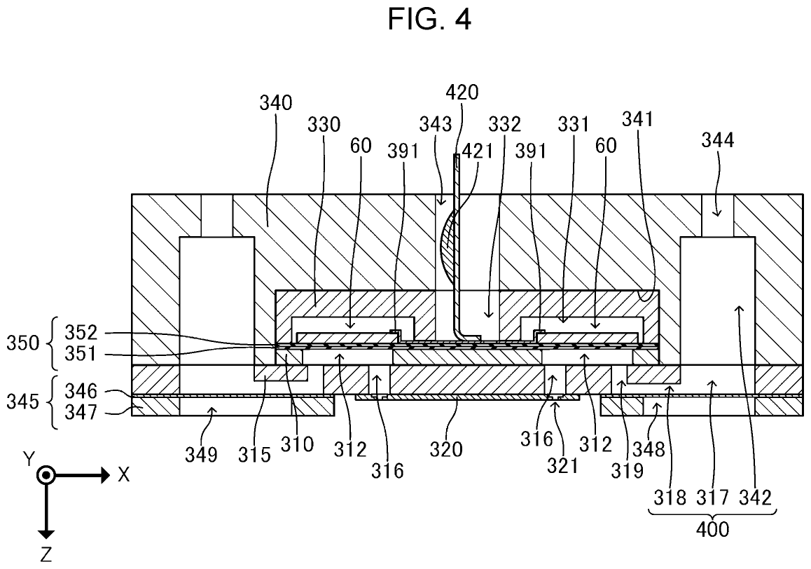

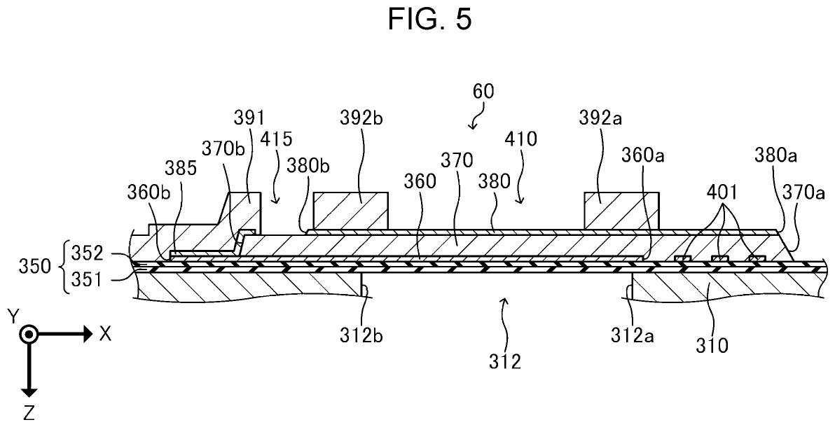

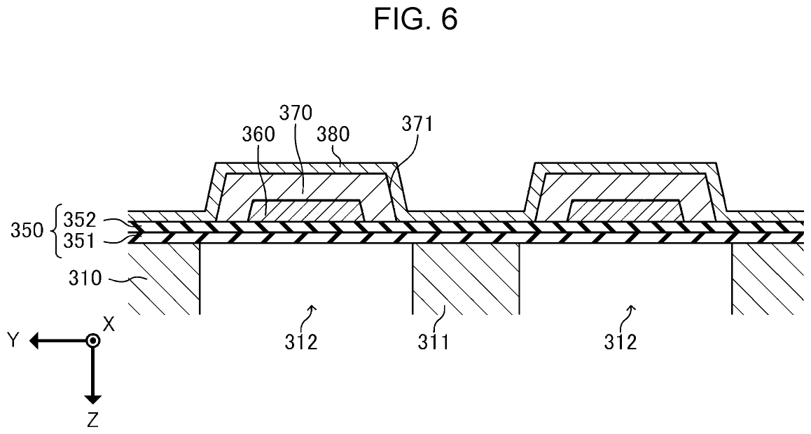

Next, an example of a structure of each of the print heads 22 included in the head unit 20 will be described. FIG. 2 is an exploded perspective view illustrating the structure of the print head 22, FIG. 3 is a plan view of the print head 22 as viewed in the direction along the Z axis, FIG. 4 is a cross-sectional view of the print head 22 taken along line IV-IV illustrated in FIG. 3, FIG. 5 is a detailed view illustrating a main section illustrated in FIG. 4, and FIG. 6 is a cross-sectional view of the print head 22 taken along line VI-VI illustrated in FIG. 3. FIG. 3 mainly illustrates a peripheral configuration of a pressure chamber substrate 310 and does not illustrate a protective substrate 330, a case member 340, and the like, and FIG. 4 illustrates a configuration of piezoelectric elements 60 in a simplified manner.

As illustrated in FIG. 2, the print head 22 includes the pressure chamber substrate 310, a communication plate 315, a nozzle plate 320, a compliance substrate 345, the protective substrate 330, the case member 340, a wiring substrate 420, a vibration plate 350 (described later), and the piezoelectric elements 60 (described later).

The pressure chamber substrate 310 includes, for example, a silicon substrate, a glass substrate, an SOI substrate, or any one or more of various ceramic substrates. As illustrated in FIG. 3, in the pressure chamber substrate 310, two pressure chamber rows, each of which includes a plurality of pressure chambers 312 aligned in the direction along the Y axis, are aligned in the direction along the X axis. In this case, the plurality of pressure chambers 312 are arranged on straight lines extending along the Y axis such that the positions of the pressure chambers 312, which form each pressure chamber row, in the direction along the X axis are the same. As illustrated in FIG. 6, the pressure chambers 312 adjacent to each other in the direction along the Y axis are partitioned by a partition wall 311. The arrangement of the pressure chambers 312 in the pressure chamber substrate 310 is not limited to the above-described arrangement. For example, the plurality of pressure chambers 312 may be arranged on straight lines extending along the Y axis such that the positions of the pressure chambers 312, which form each pressure chamber row, in the direction along the X axis are different. In the following description, of the two pressure chamber rows formed in the pressure chamber substrate 310, the pressure chamber row located on the +X side may be referred to as a first pressure chamber row, and the pressure chamber row located on the −X side of the first pressure chamber row may be referred to as a second pressure chamber row.

Each of the pressure chambers 312 is formed in a so-called rectangular shape in which the length of the pressure chamber 312 in the direction along the X axis is longer than the length of the pressure chamber 312 in the direction along the Y axis in plan view as viewed from the +Z side. Of course, the shape of each of the pressure chambers 312 in plan view as viewed from the +Z side is not limited to the rectangular shape, and may be a parallelogram shape, a polygonal shape, a circular shape, an oval shape, or the like. The oval shape refers to a shape in which both end portions in the longitudinal direction of the oval shape are formed in a semicircular shape based on a rectangular shape as a reference, and examples of the oval shape include a rectangular shape with rounded corners, an elliptical shape, an egg shape, and the like.

As illustrated in FIG. 2, the communication plate 315, the nozzle plate 320, and the compliance substrate 345 are stacked on the +Z side of the pressure chamber substrate 310.

As illustrated in FIGS. 2, 4, and 5, nozzle communication paths 316, a first manifold portion 317, a second manifold portion 318, and supply communication paths 319 are formed in the communication plate 315. The first manifold portion 317 penetrates the communication plate 315 in the direction along the Z axis. The second manifold portion 318 communicates with the first manifold portion 317, does not penetrate the communication plate 315 in the direction along the Z axis, and is open to a surface of the communication plate 315 on the +Z side. The first manifold portion 317 and the second manifold portion 318 constitute a portion of a manifold 400 serving as a common liquid chamber communicating with the plurality of pressure chambers 312. The supply communication paths 319 are independently provided corresponding to the respective pressure chambers 312. Each of the supply communication paths 319 is a path via which one end portion of the corresponding pressure chamber 312 in the direction along the X axis communicates with the second manifold portion 318. Accordingly, the ink stored in the manifold 400 is supplied to each of the pressure chambers 312. In addition, the pressure chambers 312 communicate with nozzles 321 via the nozzle communication paths 316.

As the communication plate 315, a silicon substrate, a glass substrate, an SOI substrate, various ceramic substrates, a metal substrate, and the like can be used. In addition, examples of the metal substrate include a stainless steel substrate. The communication plate 315 is preferably made of a material having a thermal expansion coefficient which is substantially the same as that of the pressure chamber substrate 310. Accordingly, even when the temperature of the pressure chamber substrate 310 and the temperature of the communication plate 315 change, it is possible to reduce the possibility that warpage may occur in the pressure chamber substrate 310 and the communication plate 315 due to a difference in thermal expansion coefficient between the pressure chamber substrate 310 and the communication plate 315.

The nozzle plate 320 is located on the side opposite to the pressure chamber substrate 310 with respect to the communication plate 315, that is, the nozzle plate 320 is located on the surface of the communication plate 315 on the +Z side. In the nozzle plate 320, the plurality of nozzles 321 communicating with the respective pressure chambers 312 via the nozzle communication paths 316 are formed. Specifically, in the nozzle plate 320, two nozzle rows in which the plurality of nozzles 321 are aligned in the direction along the Y axis are aligned in the direction along the X axis. The two nozzle rows correspond to the first pressure chamber row and the second pressure chamber row. In addition, the plurality of nozzles 321 are arranged on straight lines extending along the Y axis such that the positions of the nozzles 321, which form each nozzle row, in the direction along the X axis are the same. The arrangement of the nozzles 321 in the nozzle plate 320 is not limited to the above-described arrangement, and for example, the plurality of nozzles 321 may be arranged on straight lines extending along the Y axis such that the positions of the nozzles 321, which form each nozzle row, in the direction along the X axis are different. That is, the print head 22 according to the present embodiment has the plurality of nozzles 321, and the plurality of nozzles 321 are located side by side in the direction along the Y axis in the nozzle plate 320.

A material of the nozzle plate 320 is not particularly limited. As the material of the nozzle plate 320, for example, a silicon substrate, a glass substrate, an SOI substrate, any one or more of various ceramic substrates, or a metal substrate may be used, or an organic material such as a polyimide resin may be used. In addition, examples of the metal substrate used as the material of the nozzle plate 320 include a stainless steel substrate. However, as the material of the nozzle plate 320, a material having a thermal expansion coefficient substantially the same as the thermal expansion coefficient of the communication plate 315 is preferably used. Accordingly, when the temperature of the nozzle plate 320 and the temperature of the communication plate 315 change, it is possible to reduce the possibility that warpage may occur in the nozzle plate 320 and the communication plate 315 due to a difference in thermal expansion coefficient between the nozzle plate 320 and the communication plate 315.

The compliance substrate 345 and the nozzle plate 320 are located on the side opposite to the pressure chamber substrate 310 with respect to the communication plate 315, that is, the compliance substrate 345 and the nozzle plate 320 are located on the surface of the communication plate 315 on the +Z side. The compliance substrate 345 is located around the nozzle plate 320, and seals openings of the first manifold portion 317 and the second manifold portion 318c on the +Z side. The first manifold portion 317 and the second manifold portion 318 are formed in the communication plate 315 on the +Z side. The compliance substrate 345 includes a sealing film 346 which is a flexible thin film, and a fixed substrate 347 formed of a hard material such as metal. In addition, an opening portion 348 formed by completely removing a portion of the fixed substrate 347 in the thickness direction is formed in a region of the fixed substrate 347 facing the manifold 400. That is, one surface of the manifold 400 is a compliance portion 349 sealed by only the flexible sealing film 346.

Meanwhile, the vibration plate 350 and the piezoelectric elements 60 are stacked on the pressure chamber substrate 310 on the side opposite to the nozzle plate 320 and the like with respect to the pressure chamber substrate 310, that is, on the −Z side of the pressure chamber substrate 310. In other words, the vibration plate 350 is located on the +Z side of the piezoelectric elements 60 in the direction along the Z axis, and the pressure chamber substrate 310 is located on the +Z side of the vibration plate 350 in the direction along the Z axis.

In addition, the protective substrate 330 having substantially the same size as that of the pressure chamber substrate 310 is located on the −Z side of the pressure chamber substrate 310 and is bonded via an adhesive or the like. In the protective substrate 330, holding sections 331 that are spaces for protecting the piezoelectric elements 60 are formed. The holding sections 331 are independently provided for respective rows of the piezoelectric elements 60 aligned in the direction along the Y axis. That is, the two holding sections 331 arranged side by side in the direction along the X axis are formed in the protective substrate 330. In addition, the protective substrate 330 is located between the two holding sections 331 arranged side by side in the direction along the X axis, and a through-hole 332 is formed in the protective substrate 330 and penetrates the protective substrate 330 in the direction along the Z axis.

Further, the case member 340 that defines the pressure chamber substrate 310 and the manifold 400 communicating with the plurality of pressure chambers 312 is fixed onto the protective substrate 330. The case member 340 has substantially the same shape as that of the communication plate 315 in plan view as viewed from the −Z side, is bonded to the protective substrate 330, and is also bonded to the communication plate 315.

A housing section 341 is formed in the case member 340. The housing section 341 is a space deep enough to house the pressure chamber substrate 310 and the protective substrate 330, and has an opening wider than a surface of the protective substrate 330 bonded to the pressure chamber substrate 310 on the protective substrate 330 side of the case member 340. An opening of the housing section 341 on the nozzle plate 320 side is sealed by the communication plate 315 in a state where the pressure chamber substrate 310 and the protective substrate 330 are housed in the housing section 341.

In addition, in the case member 340, a third manifold portion 342 is formed outside the housing section 341 on both end sides of the housing section 341 in the direction along the X axis. The manifold 400 is formed by the third manifold portion 342 disposed in the case member 340, and the first manifold portion 317 and the second manifold portion 318 disposed in the communication plate 315. The manifold 400 is continuously disposed in the direction along the Y axis, and the supply communication paths 319 via which the pressure chambers 312 communicate with the manifold 400 are arranged side by side in the direction along the Y axis.

A supply port 344 for supplying ink to each manifold 400 is formed in the case member 340 so as to communicate with the manifold 400. Further, in the case member 340, a coupling port 343 that communicates with the through-hole 332 of the protective substrate 330 and through which the wiring substrate 420 is inserted is formed. The print head 22 takes in the ink stored in the ink container 90 from the supply port 344 via an ink tube or the like (not illustrated). Thus, a path extending from the manifold 400 of the print head 22 to the nozzles 321 is filled with the ink. Thereafter, a signal based on the drive signal COM is supplied from an integrated circuit 421 to each of the piezoelectric elements 60 corresponding to the pressure chambers 312. As a result, the piezoelectric elements 60 are flexurally deformed, and the vibration plate 350 is flexurally deformed due to the deformation of the piezoelectric elements 60. Due to the deformation of the vibration plate 350, the internal pressure of each of the pressure chambers 312 changes, and the ink is ejected from each of the nozzles 321 in accordance with the change in the internal pressure.

Next, details of a configuration which includes the vibration plate 350 and the piezoelectric elements 60 that are stacked and formed on the −Z side of the pressure chamber substrate 310 will be described. Each of the print heads 22 has individual lead electrodes 391, a common lead electrode 392, a measurement lead electrode 393, and resistance wiring 401 in addition to the vibration plate 350 and the piezoelectric elements 60 as a configuration in which those components are stacked on the −Z side of the pressure chamber substrate 310.

As illustrated in FIGS. 4 to 6, the vibration plate 350 includes an elastic film 351 made of silicon oxide and disposed on the pressure chamber substrate 310 side, and an insulator film 352 that is a zirconium oxide film and is disposed on the elastic film 351. In addition, a liquid flow path including the pressure chambers 312 formed in the pressure chamber substrate 310 is formed by performing anisotropic etching on the pressure chamber substrate 310 from a surface of the pressure chamber substrate 310 on the +Z side. The vibration plate 350 is located so as to seal an opening of the surface of the pressure chamber substrate 310 on the +Z side. That is, a surface of the liquid flow path on the −Z side is formed by a portion of the vibration plate 350 including the elastic film 351. The liquid flow path includes the pressure chambers 312 formed in the pressure chamber substrate 310. The configuration of the vibration plate 350 is not particularly limited. For example, the vibration plate 350 may include only one of the elastic film 351 and the insulator film 352, or may include another film other than the elastic film 351 and the insulator film 352. Examples of the other film constituting a portion of the vibration plate 350 include a silicon film and a silicon nitride film.

Each of the piezoelectric elements 60 includes an electrode 360, a piezoelectric body 370, and an electrode 380 which are sequentially stacked from the +Z side, which is the vibration plate 350 side, toward the −Z side. That is, each of the piezoelectric elements 60 includes the electrode 360, the electrode 380, and the piezoelectric body 370. The piezoelectric body 370 is disposed between the electrode 360 and the electrode 380 in the direction along the Z axis in which the electrode 360, the electrode 380, and the piezoelectric body 370 are stacked. The piezoelectric elements 60 function as piezoelectric actuators that cause changes in the pressure in the pressure chambers 312.

Specifically, both the electrode 360 and the electrode 380 are electrically coupled to the wiring substrate 420. A signal based on the drive signal COM output by the integrated circuit 421 mounted on the wiring substrate 420 is supplied to one of the electrodes 360 and 380, and a signal of a reference electrical potential propagates in the wiring substrate 420 and is supplied to the other of the electrodes 360 and 380. Accordingly, the difference in electrical potential between the signal based on the drive signal COM supplied from the integrated circuit 421 and the signal of the reference electrical potential occurs in the piezoelectric body 370. The piezoelectric body 370 is deformed due to the difference in electrical potential between the electrode 360 and the electrode 380. The vibration plate 350 is deformed or vibrated in accordance with the deformation of the piezoelectric body 370, and the volumes of the pressure chambers 312 are changed due to the deformation or vibration of the vibration plate 350. Changes in the internal pressure caused by the changes in the volumes of the pressure chambers 312 are applied to the ink stored in the pressure chambers 312, and thus the ink is ejected from the nozzles 321 via the nozzle communication paths 316. In the following description, it is assumed that the signal based on the drive signal COM output by the integrated circuit 421 mounted on the wiring substrate 420 is supplied to the electrode 360, and the signal of the reference electrical potential propagates in the wiring substrate 420 and is supplied to the electrode 380.

In the following description, in each of the piezoelectric elements 60, when a difference in electrical potential between the electrode 360 and the electrode 380 occurs, a portion in which piezoelectric strain occurs in the piezoelectric body 370 may be referred to as an active portion 410, and a portion in which piezoelectric strain does not occur in the piezoelectric body 370 may be referred to as an inactive portion 415. That is, in each of the piezoelectric elements 60, a portion where the piezoelectric body 370 is held between the electrode 360 and the electrode 380 corresponds to the active portion 410, and a portion where the piezoelectric body 370 is not held between the electrode 360 and the electrode 380 corresponds to the inactive portion 415. In the following description, when each of the piezoelectric elements 60 is driven, a portion that is deformed in the direction along the Z axis may be referred to as a flexible portion, and a portion that is not deformed in the direction along the Z axis may be referred to as a non-flexible portion. That is, in each of the piezoelectric elements 60, a portion facing the pressure chamber 312 in the direction along the Z axis corresponds to the flexible portion, and an outer portion of the pressure chamber 312 corresponds to the non-flexible portion. The active portions 410 may be referred to as active portions, and the inactive portions 415 may be referred to as inactive portions.

In general, one of the electrodes 360 and 380 located in the active portion 410 is configured as an individual electrode independent for each of the active portions 410, and the other of the electrodes 360 and 380 is configured as a common electrode common to each of the active portions 410. In the following description, it is assumed that the electrode 360 to which the signal based on the drive signal COM output by the integrated circuit 421 is supplied is individual electrodes, and the electrode 380 to which the signal of the reference electrical potential propagating in the wiring substrate 420 is supplied is a common electrode.

Specifically, the electrode 360 is located on the +Z side of the piezoelectric body 370, and is divided for each of the pressure chambers 312 to constitute an individual electrode independent for each of the active portions 410. That is, the electrodes 360 are individually provided corresponding to the respective pressure chambers 312. In addition, the electrodes 360 are formed to have a width narrower than the width of each of the pressure chambers 312 in the direction along the Y axis. That is, end portions of the electrodes 360 are located inside regions facing the pressure chambers 312 in the direction along the Y axis. In addition, end portions 360a of the electrodes 360 on the +X side and end portions 360b of the electrodes 360 on the −X side are located outside the pressure chambers 312. For example, as illustrated in FIG. 5, in the first pressure chamber row, the end portions 360a are located on the +X side of end portions 312a of the pressure chambers 312 on the +X side, and the end portions 360b are located on the −X side of end portions 312b of the pressure chambers 312 on the −X side.

A material of the electrodes 360 is not particularly limited. As the material of the electrodes 360, for example, a conductive material such as a metal such as platinum (Pt), iridium (Ir), gold (Au), or titanium (Ti), or a conductive metal oxide such as indium tin oxide abbreviated as ITO may be used, or a material obtained by stacking a plurality of materials such as platinum (Pt), iridium (Ir), gold (Au), and titanium (Ti) may be used. In the following description, it is assumed that the electrodes 360 according to the present embodiment are made of platinum (Pt).

As illustrated in FIG. 3, the piezoelectric body 370 has a predetermined length in the direction along the X axis and is continuously disposed in the direction along the Y axis. That is, the piezoelectric body 370 is continuously provided and has a predetermined thickness in the direction in which the pressure chambers 312 are aligned. The thickness of the piezoelectric body 370 is not particularly limited, and the piezoelectric body 370 is formed to have a thickness of about 1000 nanometers to 4000 nanometers, for example.

In addition, as illustrated in FIG. 5, the length of the piezoelectric body 370 in the direction along the X axis is longer than the length of each of the pressure chambers 312 in the direction along the X axis which is the longitudinal direction. Therefore, the piezoelectric body 370 extends to the outside of the pressure chambers 312 on both sides of each of the pressure chambers 312 in the direction along the X axis. Since the piezoelectric body 370 extends to the outside of the pressure chambers 312 in the direction along the X axis as described above, the strength of the vibration plate 350 is improved. Therefore, when the active portions 410 are driven, the possibility that a crack or the like may occur in the vibration plate 350 or the piezoelectric elements 60 is reduced.

Further, for example, as illustrated in FIG. 5, in the first pressure chamber row, an end portion 370a of the piezoelectric body 370 on the +X side is located on the +X side, that is, outside the end portions 360a of the electrodes 360. That is, the end portions 360a of the electrodes 360 are covered with the piezoelectric body 370. Meanwhile, an end portion 370b of the piezoelectric body 370 on the −X side is located on the +X side, that is, inside the end portions 360b of the electrodes 360. That is, the end portions 360b of the electrodes 360 are not covered with the piezoelectric body 370.

In addition, as illustrated in FIGS. 3 and 6, a groove portion 371 is formed in the piezoelectric body 370 so as to correspond to each partition wall 311 and has a thickness less than those of the other regions of the piezoelectric body 370. The groove portion 371 described in the present embodiment is formed by completely removing a portion of the piezoelectric body 370 in the direction along the Z axis. That is, a case where the piezoelectric body 370 has the portion having the thickness less than those of the other regions is not limited to a case where the groove portion 371 is formed in the piezoelectric body 370 and has the thickness less than those of the other portions, and includes a case where the portion of the piezoelectric body 370 is completely removed in the direction along the Z axis. In addition, the length of the groove portion 371 in the direction along the Y axis, that is, the width of the groove portion 371 is greater than or equal to than the width of the partition wall 311. In the present embodiment, the width of the groove portion 371 is greater than the width of the partition wall 311. The groove portion 371 is formed to have a rectangular shape in plan view as viewed from the −Z side. Of course, the shape of the groove portion 371 in plan view as viewed from the −Z side is not limited to the rectangular shape, and may be a polygonal shape having five or more sides, a circular shape, an elliptical shape, or the like.

By providing the groove portion 371 in the piezoelectric body 370, it is possible to reduce the rigidity of a portion of the vibration plate 350 facing the end portions of the pressure chambers 312 in the direction along the Y axis, that is, the rigidity of an arm portion of the vibration plate 350, and thus it is possible to more favorably deform the piezoelectric elements 60.

Examples of the piezoelectric body 370 include a crystal film formed on the electrodes 360, having a perovskite structure, and made of a ferroelectric ceramic material exhibiting electromechanical transduction properties, a so-called perovskite type crystal. As a material of the piezoelectric body 370, for example, a ferroelectric piezoelectric material such as lead zirconate titanate (PZT) or a material obtained by adding, to the ferroelectric piezoelectric material, metal oxide such as niobium oxide, nickel oxide, or magnesium oxide may be used. Specifically, as the material of the piezoelectric body 370, lead titanate (PbTiO₃), lead zirconate titanate (Pb(Zr,Ti)O₃), lead zirconate (PbZro₃), lead lanthanum titanate ((Pb,La),TiO₃), lead lanthanum zirconate titanate ((Pb,La)(Zr,Ti)O₃), or lead zirconium titanate magnesium niobate (Pb(Zr,Ti)(Mg,Nb)O₃) can be used. In the present embodiment, it is assumed that the piezoelectric body 370 is made of lead zirconate titanate (PZT).

The material of the piezoelectric body 370 is not limited to a lead-based piezoelectric material containing lead, and a non-lead-based piezoelectric material containing no lead can also be used as the material of the piezoelectric body 370. Examples of the non-lead-based piezoelectric material include bismuth ferrate ((BiFeO₃), abbreviated to “BFO”), barium titanate ((BaTiO₃), abbreviated to “BT”), potassium sodium niobate ((K,Na)(NbO₃), abbreviated to “KNN”), potassium sodium lithium niobate ((K,Na,Li)(NbO₃)), potassium sodium lithium tantalate niobate ((K,Na,Li)(Nb,Ta)O₃), bismuth potassium titanate ((Bi_{1/2}K_{1/2})TiO₃, abbreviated to “BKT”), bismuth sodium titanate ((Bi_{1/2}Na_{1/2})TiO₃, abbreviated to “BNT”), bismuth manganate (BiMnO₃, abbreviated to “BM”), a complex oxide (x[(BixK1-x)TiO3]-(1-x)[BiFeO₃]), abbreviated to “BKT-BF”) containing bismuth, potassium, titanium, and iron and having a perovskite structure, a complex oxide ((1-x)[BiFeO₃]-x[BaTiO₃], abbreviated to “BFO-BT”) containing bismuth, iron, barium, and titanium and having a perovskite structure, and a material ((1-x)[Bi(Fe_{1-y}M_{y})O₃]-x[BaTiO₃], where M is Mn, Co or Cr)) obtained by adding, to the complex oxide BFO-BT, a metal such as manganese, cobalt, or chromium.

As illustrated in FIGS. 3, 5, and 6, the electrode 380 is located on the −Z side of the piezoelectric body 370 on the side opposite to the electrodes 360 with respect to the piezoelectric body 370, and constitutes a common electrode common to the plurality of active portions 410. That is, the electrode 380 is provided in common to the plurality of pressure chambers 312. The electrode 380 has a predetermined length in the direction along the X axis and is continuously disposed in the direction along the Y axis. The electrode 380 is also disposed on an inner surface of the groove portion 371, that is, on a side surface of the groove portion 371 of the piezoelectric body 370 and on the insulator film 352 which is the bottom surface of the groove portion 371. Regarding the inside of the groove portion 371, the electrode 380 may be disposed only on a portion of the inner surface of the groove portion 371 or may not be disposed on the entire inner surface of the groove portion 371.

Further, for example, as illustrated in FIG. 5, in the first pressure chamber row, an end portion 380a of the electrode 380 on the +X side is located on the +X side so as to be outside the end portions 360a of the electrodes 360 covered with the piezoelectric body 370. That is, the end portion 380a of the electrode 380 is located on the +X side, that is, outside the end portion 312a of the pressure chamber 312, and is outside the end portions 360a of the electrodes 360. In the present embodiment, the end portion 380a of the electrode 380 substantially matches the end portion 370a of the piezoelectric body 370 in the direction along the X axis. Therefore, end portions of the active portions 410 on the +X side, that is, boundaries between the active portions 410 and the inactive portions 415 are defined by the end portions 360a of the electrodes 360.

On the other hand, an end portion 380b of the electrode 380 on the −X side is located on the −X side, that is, outside the end portions 312b of the pressure chambers 312, and on the +X side, that is, inside the end portion 370b of the piezoelectric body 370. As described above, the end portion 370b of the piezoelectric body 370 is located on the +X side, that is, inside the end portions 360b of the electrodes 360. Therefore, the end portion 380b of the electrode 380 is located on the piezoelectric body 370 on the +X side of the end portions 360b of the electrodes 360. Therefore, an exposed portion of a front surface of the piezoelectric body 370 is present on the −X side of the end portion 380b of the electrode 380. As described above, the end portion 380b of the electrode 380 is disposed on the +X side of the end portion 370b of the piezoelectric body 370 and the end portions 360b of the electrodes 360. Therefore, end portions of the active portions 410 on the −X side, that is, boundaries between the active portions 410 and the non-active portions 415 are defined by the end portion 380b of the electrode 380.

A material of the electrode 380 is not particularly limited. For example, similarly to the electrodes 360, as the material of the electrode 380, a conductive material such as a metal such as platinum (Pt), iridium (Ir), gold (Au), or titanium (Ti), or a conductive metal oxide such as indium tin oxide abbreviated as ITO may be used, or a material obtained by stacking a plurality of materials such as platinum (Pt), iridium (Ir), gold (Au), and titanium (Ti) may be used. In the present embodiment, it is assumed that the material of the electrode 380 is iridium (Ir).

Wiring portions 385 that are in the same layer as a layer in which the electrode 380 is disposed but are electrically discontinuous from the electrode 380 are disposed outside the end portion 380b of the electrode 380, that is, on the −X side of the end portion 380b of the electrode 380. In addition, the wiring portions 385 are formed on the piezoelectric body 370 and on the electrodes 360 extending further to the −X side than the piezoelectric body 370 in a state in which the wiring portions 385 are spaced apart from the end portion 380b of the electrode 380 without being in contact with the end portion 380b of the electrode 380. The wiring portions 385 are provided independently for the respective active portions 410. That is, the plurality of wiring portions 385 are arranged at predetermined intervals in the direction along the Y axis. Note that the wiring portions 385 may be formed in a layer different from the layer in which the electrode 380 is disposed, but is preferably formed in the same layer as the layer in which the electrode 380 is disposed. As a result, a process of producing the wiring portions 385 can be simplified, so that the cost can be reduced.

In addition, the individual lead electrodes 391 are coupled to the electrodes 360 included in the piezoelectric elements 60, and the common lead electrode 392 which is a common electrode for driving is electrically coupled to the electrode 380. While end portions of the individual lead electrodes 391 and an end portion of the common lead electrode 392 are coupled to the piezoelectric elements 60, the wiring substrate 420 is electrically coupled to opposite end portions of the individual lead electrodes 391 and an opposite end portion of the common lead electrode 392. Wiring for coupling the control unit 10, a temperature information output circuit 26, and a plurality of circuits (not illustrated) is formed on the wiring substrate 420. The wiring substrate 420 includes, for example, a flexible printed circuit (FPC).

In the present embodiment, the individual lead electrodes 391 and the common lead electrode 392 are extended so as to be exposed in the through-hole 332 formed in the protective substrate 330, and are electrically coupled to the wiring substrate 420 in the through-hole 332. The integrated circuit 421 that outputs a signal for driving the piezoelectric elements 60 is mounted on the wiring substrate 420.

In the present embodiment, the individual lead electrodes 391 and the common lead electrode 392 are formed in the same layer, but are electrically discontinuous from each other. Accordingly, it is possible to simplify a manufacturing process and reduce the cost compared to a case where the individual lead electrodes 391 and the common lead electrode 392 are individually formed. Of course, a layer in which the individual lead electrodes 391 are formed may be different from a layer in which the common lead electrode 392 is formed.

A material of the individual lead electrodes 391 and the common lead electrodes 392 is not particularly limited as long as the material has conductivity, and for example, gold (Au), copper (Cu), titanium (Ti), tungsten (W), nickel (Ni), chromium (Cr), platinum (Pt), aluminum (Al), or the like can be used as the material of the individual lead electrodes 391 and the common lead electrodes 392. In the present embodiment, it is assumed that the individual lead electrodes 391 and the common lead electrode 392 are made of gold (Au). The individual lead electrodes 391 and the common lead electrode 392 may include an adhesion layer for improving adhesion to the electrodes 360, the electrode 380, and the vibration plate 350.

The individual lead electrodes 391 are provided for the respective active portions 410, that is, for the respective electrodes 360. For example, as illustrated in FIG. 5, in the first pressure chamber row, the individual lead electrodes 391 are coupled via the wiring portions 385 to portions in the vicinities of the end portions 360b of the electrodes 360 disposed outside the piezoelectric body 370, and are drawn out onto the pressure chamber substrate 310, actually onto the vibration plate 350 in the direction along the X axis.

Meanwhile, as illustrated in FIG. 3, in the first pressure chamber row, the common lead electrode 392 is drawn out to the −X side from positions on the electrode 380 constituting the common electrode on the piezoelectric body 370 onto the vibration plate 350 at both end portions of the common lead electrode 392 in the direction along the Y axis. Further, the common lead electrode 392 has an extension portion 392a and an extension portion 392b. As illustrated in FIGS. 3 and 5, for example, in the first pressure chamber row, the extension portion 392a extends in the direction along the Y axis in a region corresponding to the end portions 312a of the pressure chambers 312, and the extension portion 392b extends in the direction along the Y axis in a region corresponding to the end portions 312b of the pressure chambers 312. The extension portion 392a and the extension portion 392b are disposed continuously in the direction along the Y axis with respect to the plurality of active portions 410.

In addition, the extension portion 392a and the extension portion 392b extend from the inside of the pressure chambers 312 to the outside of the pressure chambers 312 in the direction along the X axis. In the present embodiment, the active portions 410 of the piezoelectric elements 60 extend to the outside of the pressure chambers 312 at both end portions of each of the pressure chambers 312 in the direction along the X axis, and the extension portion 392a and the extension portion 392b extend to the outside of the pressure chambers 312 on the active portions 410.

As illustrated in FIG. 5, the resistance wiring 401 is disposed on a surface of the vibration plate 350 on the −Z side. The resistance wiring 401 detects the temperatures of the pressure chambers 312 by using a characteristic in which an electric resistance value of the resistance wiring 401 changes depending on temperature. As a material of the resistance wiring 401, a material whose electric resistance value has temperature dependency, for example, gold (Au), platinum (Pt), iridium (Ir), aluminum (Al), copper (Cu), titanium (Ti), tungsten (W), nickel (Ni), chromium (Cr), or the like can be used.

Among these, platinum (Pt) has a resistance value which greatly changes due to temperature, and has high stability and accuracy. Further, platinum (Pt) has high linearity in a change in the resistance value with respect to a change in temperature. From such a viewpoint, platinum (Pt) is preferably used as the material of the resistance wiring 401. That is, the resistance wiring 401 preferably includes platinum (Pt). In addition, in the present embodiment, the resistance wiring 401 is in the same layer as a layer in which the electrodes 360 are disposed, and is stacked and formed on the surface of the vibration plate 350 on the −Z side so as to be electrically discontinuous from the electrodes 360. That is, the resistance wiring 401 includes a wiring pattern stacked on the surface of the vibration plate 350 on the −Z side in the direction along the Z axis, and the wiring pattern includes platinum (Pt).

As illustrated in FIG. 3, one end of the resistance wiring 401 is coupled to a measurement lead electrode 393a, and the other end of the resistance wiring 401 is coupled to a measurement lead electrode 393b. The measurement lead electrodes 393a and 393b are electrically coupled to the wiring substrate 420. Accordingly, the print head 22 outputs a signal having a voltage value corresponding to the electrical resistance value which changes depending on the temperatures of the pressure chambers 312 detected by the resistance wiring 401.

In addition, in the present embodiment, the resistance wiring 401 is covered with the piezoelectric body 370, and is located between the vibration plate 350 and the piezoelectric body 370 in the direction along the Z axis. The resistance wiring 401 includes a first pressure chamber row side meandering pattern located on the +X side in the direction along the X axis and a second pressure chamber row side meandering pattern located on the −X side in the direction along the X axis. The first pressure chamber row side meandering pattern is located so as to overlap the supply communication paths 319 communicating with the respective pressure chambers 312 constituting the first pressure chamber row and meanders in the direction along the Y axis as viewed from the −Z side. The second pressure chamber row side meandering pattern is located so as to overlap the supply communication paths 319 communicating with the respective pressure chambers 312 constituting the second pressure chamber row and meanders in the direction along the Y axis as viewed from the −Z side. That is, the resistance wiring 401 includes the first pressure chamber row side meandering pattern corresponding to the first pressure chamber row formed by the plurality of pressure chambers 312 and the second pressure chamber row side meandering pattern corresponding to the second pressure chamber row formed by the plurality of pressure chambers 312.

As illustrated in FIGS. 4 and 5, a distance between an end portion of each of the pressure chambers 312 on the −Z side and the resistance wiring 401 in the direction along the Z axis is shorter than a dimension of each of the pressure chambers 312 in the direction along the Z axis. In addition, for example, in the first pressure chamber row, the longest distance among distances between the end portions 312a of the pressure chambers 312 on the +X side and the resistance wiring 401 in the direction along the X axis is shorter than a dimension of each of the pressure chambers 312 in the direction along the X axis. Therefore, the electric resistance value of the resistance wiring 401 easily changes in response to a change in the temperatures of the pressure chambers 312.

In the present embodiment, the measurement lead electrode 393 that includes the measurement lead electrode 393a and the measurement lead electrode 393b is formed in the same layer as the layer in which the individual lead electrodes 391 and the common lead electrode 392 are disposed, but are electrically discontinuous from the individual lead electrodes 391 and the common lead electrode 392. Accordingly, it is possible to simplify the manufacturing process and reduce the cost compared to a case where the measurement lead electrode 393 is formed separately from the individual lead electrodes 391 and the common lead electrode 392. Of course, the measurement lead electrode 393 may be formed in a layer different from the layer in which individual lead electrodes 391 and the common lead electrode 392 are disposed.

A material of the measurement lead electrode 393 is not particularly limited as long as the material has conductivity, and for example, gold (Au), copper (Cu), titanium (Ti), tungsten (W), nickel (Ni), chromium (Cr), platinum (Pt), aluminum (Al), or the like can be used as the material of the measurement lead electrode 393. In the following description, it is assumed that the measurement lead electrode 393 in the present embodiment is made of gold (Au). That is, the material of the measurement lead electrode 393 in the present embodiment is the same as that of the individual lead electrodes 391 and the common lead electrode 392. In addition, the measurement lead electrode 393 may include an adhesion layer that improves adhesion to the resistance wiring 401 or the vibration plate 350.

As described above, in the present embodiment, the measurement lead electrode 393 is extended so as to be exposed in the through-hole 332 formed in the protective substrate 330, and is electrically coupled to the wiring substrate 420 in the through-hole 332. Accordingly, the electric resistance value of the resistance wiring 401 that changes according to the temperature of each of the pressure chambers 312 is output by the print head 22 via the wiring substrate 420.

That is, the print head 22 included in the head unit 20 according to the present embodiment includes the electrode 360, the electrode 380, and the piezoelectric body 370. The piezoelectric body 370 is located between the electrode 360 and the electrode 380 in the direction along the Z axis in which the electrode 360, the electrode 380, and the piezoelectric body 370 are stacked. The print head 22 includes the piezoelectric element 60 that receives the drive signal COM and is driven in response to the drive signal COM, the vibration plate 350 that is located on the +Z side, which is one side of the piezoelectric element 60 in the direction along the Z axis, and is deformed by the driving of the piezoelectric element 60, the pressure chamber substrate 310 that is located on the +Z side, which is one side of the vibration plate 350 in the direction along the Z axis, and is provided with the pressure chamber 312 in which ink is stored and that changes in volume due to the deformation of the vibration plate 350, the nozzle 321 from which the ink is ejected in accordance with the change in the volume of the pressure chamber 312, and the resistance wiring 401 that is located on the −Z side, which is the other side of the vibration plate 350 in the direction along the Z axis, and acquires a temperature corresponding to the temperature of the pressure chamber 312.

### 3. Configuration of Liquid Ejecting Apparatus

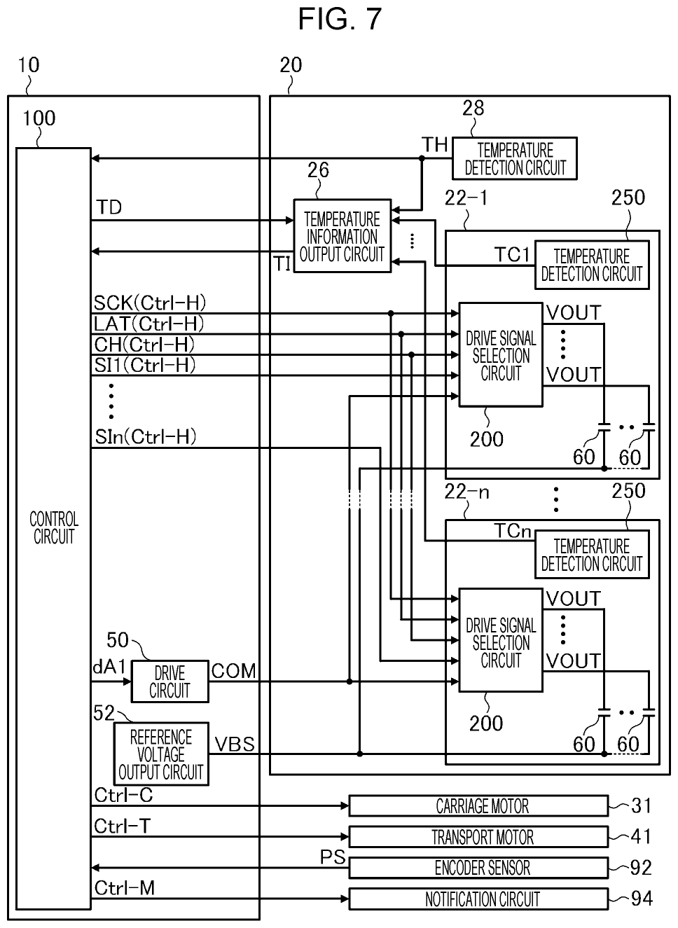

Next, a functional configuration of the liquid ejecting apparatus 1 will be described. FIG. 7 is a diagram illustrating the functional configuration of the liquid ejecting apparatus 1. As illustrated in FIG. 7, the liquid ejecting apparatus 1 includes the control unit 10, the head unit 20, the carriage motor 31, the transport motor 41, an encoder sensor 92, and a notification circuit 94.

The control unit 10 includes a drive circuit 50, a reference voltage output circuit 52, and a control circuit 100. The control circuit 100 includes, for example, a processing circuit such as a CPU or an FPGA, and a storage circuit such as a semiconductor memory. An image information signal including image data or the like is input to the control circuit 100 from an external apparatus such as a host computer which is provided outside the liquid ejecting apparatus 1 and communicably coupled to the liquid ejecting apparatus 1. The control circuit 100 generates, based on the input image information signal, various signals for controlling the liquid ejecting apparatus 1 and outputs the signals to corresponding components. That is, the control circuit 100 controls the print heads 22 and the drive circuit 50 which will be described later.

In a specific example, in addition to the image information signal described above, a position detection signal PS based on the scanning position of the carriage 21 included in the head unit 20 is input from the encoder sensor 92 to the control circuit 100. The control circuit 100 grasps, based on the input position detection signal PS, the scanning position of the carriage 21, that is, the scanning position of the head unit 20 including the print heads 22 mounted on the carriage 21. Then, the control circuit 100 generates various signals corresponding to the input image information signal and the grasped scanning position of the head unit 20, and outputs the signals to the corresponding components.

In detail, the control circuit 100 generates the control signal Ctrl-C for controlling the movement of the head unit 20 along the scanning axis according to the scanning position of the head unit 20, and outputs the control signal Ctrl-C to the carriage motor 31. Accordingly, the carriage motor 31 operates, and the movement of the head unit 20 mounted on the carriage 21 along the scanning axis and the scanning position of the head unit 20 are controlled. In addition, the control circuit 100 generates the control signal Ctrl-T for controlling the transport of the medium P and outputs the control signal Ctrl-T to the transport motor 41. Accordingly, the transport motor 41 operates, and the movement of the medium P along the transport direction is controlled. The control signal Ctrl-C may be input to the carriage motor 31 after being subjected to signal conversion via a driver circuit (not illustrated), and the control signal Ctrl-T may be input to the transport motor 41 after being subjected to signal conversion via a driver circuit (not illustrated).

In addition, the control circuit 100 generates, based on the image information signal input from the external apparatus and the scanning position of the head unit 20, print data signals SI1 to SIn, a change signal CH, a latch signal LAT, and a clock signal SCK as the control signal Ctrl-H for controlling the head unit 20 and outputs the generated signals to the head unit 20.

Further, the control circuit 100 generates a temperature acquisition request signal TD for acquiring information of the temperature of the head unit 20, and outputs the temperature acquisition request signal TD to the head unit 20. Accordingly, a temperature information signal TI including the information of the temperature of the head unit 20 corresponding to the temperature acquisition request signal TD is input to the control circuit 100. The control circuit 100 grasps the temperature of the head unit 20 based on the input temperature information signal TI, corrects the control signals Ctrl-H, Ctrl-C, and Ctrl-T based on the grasped temperature, and outputs the corrected control signals Ctrl-H, Ctrl-C, and Ctrl-T to corresponding components. Accordingly, the operations of the liquid ejecting apparatus 1 and the head unit 20 are controlled according to the temperatures of the print heads 22, that is, the temperature information signal TI. As a result, the accuracy of ejecting the ink from the liquid ejecting apparatus 1 and the head unit 20 is improved.

In addition, the control circuit 100 generates a base drive signal dA which is a digital signal as the control signal Ctrl-H, and outputs the base drive signal dA to the drive circuit 50. The drive circuit 50 generates, as the drive signal COM, a drive signal COM having a signal waveform defined by the base drive signal dA, and outputs the generated drive signal COM to the head unit 20.

Specifically, the base drive signal dA output by the control circuit 100 is input to the drive circuit 50. The drive circuit 50 generates the drive signal COM by converting the input base drive signal dA from a digital signal to an analog signal and then performing Class D amplification on the converted analog signal, and outputs the generated drive signal COM to the head unit 20. That is, the control circuit 100 outputs the base drive signal dA as the control signal Ctrl-H corrected based on the temperature information signal TI, and the drive circuit 50 outputs the drive signal COM having the corrected signal waveform corresponding to the base drive signal dA corrected based on the temperature information signal TI. The description will be made assuming that the base drive signal dA output by the control circuit 100 is a digital signal which defines the signal waveform of the drive signal COM, but the base drive signal dA may be an analog signal as long as the base drive signal dA defines the signal waveform of the drive signal COM. Further, the drive circuit 50 may generate the drive signal COM by performing Class A amplification, Class B amplification, or Class AB amplification on the signal waveform defined by the base drive signal dA.

As described above, the drive circuit 50 generates and outputs the drive signal COM based on the base drive signal dA. In this case, the base drive signal dA output by the control circuit 100 and input to the drive circuit 50 is also corrected based on the temperature of the head unit 20 grasped based on the temperature information signal TI. Therefore, the drive circuit 50 outputs the drive signal COM corrected based on the temperature of the head unit 20.

The reference voltage output circuit 52 generates a reference voltage signal VBS and outputs the reference voltage signal VBS to the head unit 20. The reference voltage signal VBS has a constant voltage value serving as a reference for driving the piezoelectric elements 60, and is supplied to the electrode 380 serving as a common electrode. The reference voltage signal VBS may be, for example, a signal that is constant at a ground electrical potential, or may be a signal that is constant at an electrical potential of 5.5 V, 6 V, or the like.

In addition, the control circuit 100 generates a control signal Ctrl-M for notifying a user of operation states of the drive circuit 50, the reference voltage output circuit 52, and the head unit 20, and outputs the control signal Ctrl-M to the notification circuit 94. The notification circuit 94 notifies the user of information corresponding to the control signal Ctrl-M. Thus, the user is notified of the operation state of the liquid ejecting apparatus 1. The notification circuit 94 may be a display that notifies the information by using a character or an image, or may be a speaker that notifies the information by using a sound.

The head unit 20 includes print heads 22-1 to 22-n as the plurality of print heads 22, the temperature information output circuit 26, and a temperature detection circuit 28. Further, each of the print heads 22-1 to 22-n includes a drive signal selection circuit 200, a temperature detection circuit 250, and a plurality of piezoelectric elements 60.

The print data signal SI1, the change signal CH, the latch signal LAT, the clock signal SCK, the drive signal COM, and the reference voltage signal VBS are output by the control circuit 100 and input to the print head 22-1. The clock signal SCK, the latch signal LAT, the change signal CH, the print data signal SI1, and the drive signal COM input to the print head 22-1 are input to the drive signal selection circuit 200.

The drive signal selection circuit 200 generates a drive signal VOUT corresponding to each of the plurality of piezoelectric elements 60 by selecting or not selecting a signal waveform included in the drive signal COM based on the clock signal SCK, the latch signal LAT, the change signal CH, and the print data signal SI1 input to the drive signal selection circuit 200. Then, the drive signal selection circuit 200 outputs the generated drive signal VOUT to each of the electrodes 360 as individual electrodes that is one end of each of the corresponding piezoelectric elements 60. In this case, the reference voltage signal VBS is commonly input to the electrode 380 which is the other end of each of the plurality of piezoelectric elements 60 and is a common electrode. Accordingly, each of the plurality of piezoelectric elements 60 is deformed due to a difference in electrical potential between the drive signal VOUT input to each of the electrodes 360 and the reference voltage signal VBS input to the electrode 380. As a result, the ink in amounts corresponding to the deformation of the piezoelectric elements 60 is ejected from the corresponding nozzles 321 included in the print head 22-1.

That is, the print head 22-1 receives the drive signal COM and ejects the ink in response to the drive signal COM. At least a portion of the drive signal selection circuit 200 may be mounted on the wiring substrate 420 of the print head 22-1 as the integrated circuit 421 described above.

The temperature detection circuit 250 included in the print head 22-1 detects the temperature of the print head 22-1. Then, the temperature detection circuit 250 outputs a head temperature signal TC1 corresponding to the detected temperature of the print head 22-1 to the temperature information output circuit 26. A portion of the temperature detection circuit 250 may be disposed in the print head 22-1, and another portion of the temperature detection circuit 250 may be disposed outside the print head 22-1. In this case, the portion of the temperature detection circuit 250 disposed in the print head 22-1 corresponds to the resistance wiring 401 described above. That is, a voltage value of the head temperature signal TC1 which corresponds to the temperature of the print head 22-1 and is output by the temperature detection circuit 250 changes according to the resistance value of the resistance wiring 401 that changes according to the temperature. In other words, the voltage value of the head temperature signal TC1 which is output by the temperature detection circuit 250 changes according to the temperature of the print head 22-1, that is, the temperature of each of the pressure chambers 312 of the print head 22-1.

The print heads 22-2 to 22-n have the same configuration as that of the print head 22-1 except that signals input to the print heads 22-2 to 22-n and signals output by the print heads 22-2 to 22-n are different from the signals input to the print head 22-1 and the signals output from the print head 22-1. The print heads 22-2 to 22-n execute similar operations to that of the print head 22-1. Specifically, the clock signal SCK, the latch signal LAT, the change signal CH, the print data signal SIi, the drive signal COM, and the reference voltage signal VBS are input to a print head 22-i among the print heads 22-2 to 22-n (i is any one of 2 to n). The drive signal selection circuit 200 included in the print head 22-i generates a drive signal VOUT corresponding to each of the plurality of piezoelectric elements 60 by selecting or not selecting a signal waveform included in the drive signal COM based on the clock signal SCK, the latch signal LAT, the change signal CH, and the print data signal SIi input to the drive signal selection circuit 200, and outputs the generated drive signals VOUT to the electrodes 360 of the corresponding piezoelectric elements 60. In addition, the reference voltage signal VBS is commonly input to the electrode 380 of the plurality of piezoelectric elements 60 included in the print head 22-i. Accordingly, the plurality of piezoelectric elements 60 included in the print head 22-i are driven, and ink in amounts corresponding to the driving of the piezoelectric elements 60 is ejected from the nozzles 321 included in the print head 22-i. That is, the print heads 22-2 to 22-n also receive the drive signal COM and eject the ink in response to the drive signal COM.

The temperature detection circuit 250 included in the print head 22-i outputs a head temperature signal TCi having a voltage value corresponding to the temperature of the print head 22-i to the temperature information output circuit 26. At least a portion of the drive signal selection circuit 200 included in the print head 22-i is mounted on the wiring substrate 420 of the print head 22-i as the integrated circuit 421 described above, and at least a portion of the temperature detection circuit 250 included in the print head 22-i is disposed in the print head 22-i as the resistance wiring 401 described above.

In the following description, it is assumed that the clock signal SCK, the latch signal LAT, the change signal CH, print data signals SI as the print data signals SI1 to SIn, the drive signal COM, and the reference voltage signal VBS are input to the print heads 22-1 to 22-n, which may be referred to as the print heads 22 when the print heads 22-1 to 22-n are not distinguished. In addition, it is assumed that the temperature detection circuits 250 of the print heads 22 output head temperature signals TC having voltage values corresponding to the temperatures of the print heads 22 as head temperature signals TC1 to TCn.

The temperature detection circuit 28 detects the temperature of the head unit 20 including the print heads 22-1 to 22-n. Then, the temperature detection circuit 28 generates a unit temperature signal TH having a voltage value corresponding to the detected temperature. The temperature detection circuit 28 outputs the generated unit temperature signal TH to the temperature information output circuit 26 and the control circuit 100. The temperature detection circuit 28 includes a thermistor element having a resistance value that changes in accordance with a change in the temperature of the head unit 20.

The temperature information output circuit 26 generates the temperature information signal TI according to the head temperature signals TC1 to TCn output by the print heads 22-1 to 22-n, respectively, the unit temperature signal TH output by the temperature detection circuit 28, and the temperature acquisition request signal TD output by the control circuit 100, and outputs the generated temperature information signal TI to the control circuit 100. That is, the temperature information output circuit 26 acquires the head temperature signals TC1 to TCn corresponding to the temperatures of the print heads 22, and outputs the temperature information signal TI corresponding to the acquired head temperature signals TC1 to TCn.

Specifically, the temperature information output circuit 26 selects a head temperature signal TC from among the head temperature signals TC1 to TCn according to the temperature acquisition request signal TD input from the control circuit 100, and amplifies the selected head temperature signal TC. Then, the temperature information output circuit 26 corrects, based on the unit temperature signal TH, a signal obtained by amplifying the selected head temperature signal TC, and outputs the temperature information signal TI corresponding to the corrected signal to the control circuit 100. The configuration and operation of the temperature information output circuit 26 will be described in detail later.

### 4. Signal Waveform of Drive Signal COM and Configuration of Drive Signal Selection Circuit

Next, the configuration and operation of the drive signal selection circuit 200 included in each of the print heads 22 will be described. As described above, the drive signal selection circuit 200 included in the print head 22 generates drive signals VOUT by selecting or not selecting a signal waveform included in the drive signal COM based on the clock signal SCK, the print data signal SI, the latch signal LAT, and the change signal CH, and outputs the drive signals VOUT to the corresponding piezoelectric elements 60. Before describing the configuration and operation of the drive signal selection circuit 200, first, an example of the waveform of the drive signal COM which is input to the drive signal selection circuit 200 in a period in which ink is ejected onto the medium P will be described. In the following description, the period in which the ink is ejected onto the medium P may be referred to as an ejection period.

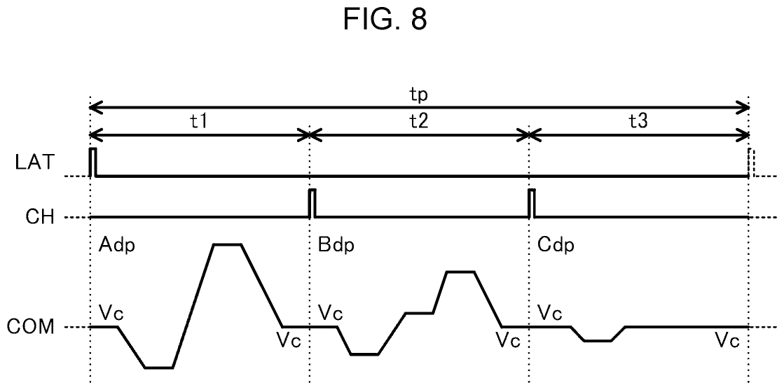

FIG. 8 is a diagram illustrating an example of the signal waveform of the drive signal COM in the ejection period. As illustrated in FIG. 8, in the ejection period, the drive signal COM includes a trapezoidal waveform Adp in a period t1 from a first rising edge of the latch signal LAT to a first rising edge of the change signal CH, a trapezoidal waveform Bdp in a period t2 from the first rising edge of the change signal CH to a second rising edge of the change signal CH, and a trapezoidal waveform Cdp in a period t3 from the second rising edge of the change signal CH to a second rising edge of the latch signal LAT. The trapezoidal waveform Adp is a signal waveform for driving the piezoelectric element 60 such that a predetermined amount of ink is ejected, the trapezoidal waveform Bdp is a signal waveform for driving the piezoelectric element 60 such that a smaller amount of ink than the predetermined amount is ejected, and the trapezoidal waveform Cdp is a signal waveform for driving the piezoelectric element 60 such that ink is not ejected. The trapezoidal waveform Cdp is a signal waveform for vibrating ink in the vicinity of an opening portion of the corresponding nozzle to reduce the possibility that the viscosity of the ink in the vicinity of the opening portion of the nozzle may increase when the trapezoidal waveform Cdp is supplied to the corresponding piezoelectric element 60.

Each of the trapezoidal waveforms Adp, Bdp, and Cdp is a common signal waveform in which a voltage value at each of the start timing and the end timing of the trapezoidal waveform is a voltage Vc. That is, each of the trapezoidal waveforms Adp, Bdp, and Cdp starts at the voltage Vc and ends at the voltage Vc.

In the following description, the predetermined amount of ink ejected when the trapezoidal waveform Adp is supplied to the piezoelectric element 60 may be referred to as a medium amount, and the amount of ink which is ejected when the trapezoidal waveform Bdp is supplied to the piezoelectric element 60, and is smaller than the predetermined amount may be referred to as a small amount. In addition, an operation for preventing an increase in the viscosity of ink by vibrating the ink in the vicinity of the opening portion of the nozzle corresponding to the piezoelectric element 60 when the trapezoidal waveform Cdp is supplied to the piezoelectric element 60 may be referred to as minute vibration. The signal waveform of the drive signal COM illustrated in FIG. 8 is an example and is not limited thereto, and various combinations of waveforms may be used according to the properties of the ink to be ejected, the material of the medium P on which the ink lands, and the like.

The drive signal selection circuit 200 selects or does not select the trapezoidal waveforms Adp, Bdp, and Cdp included in the drive signal COM in a period tp including the periods t1, t2, and t3. Accordingly, the drive signal selection circuit 200 controls the amount of ink to be ejected from each of the plurality of nozzles 321 in the period tp. That is, the drive signal selection circuit 200 controls a size of a dot to be formed on the medium P in the period tp. A dot of a predetermined size is formed on the medium P in the period tp including the periods t1, t2, and t3. The period tp in which the dot of the predetermined size is formed corresponds to a dot formation period.

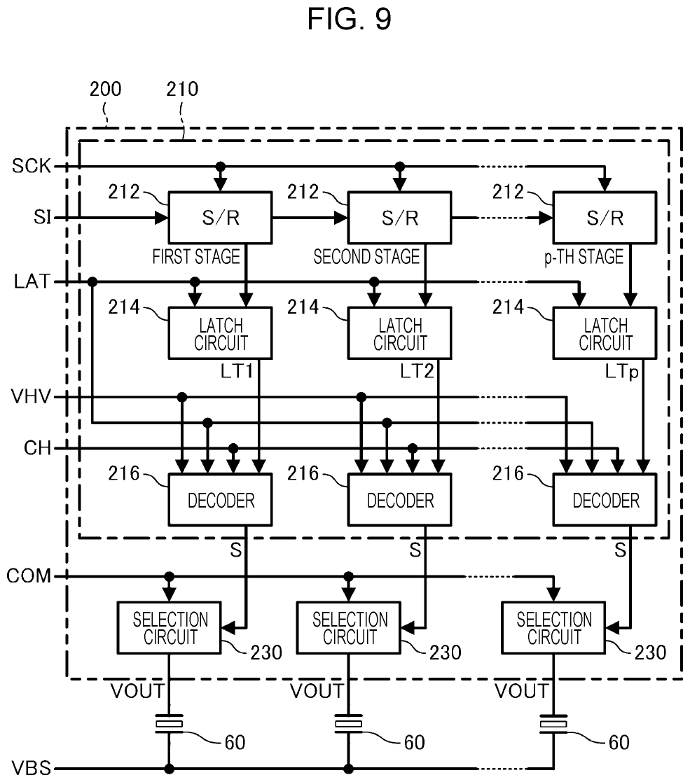

Next, the configuration and operation of the drive signal selection circuit 200 that generates drive signals VOUT by selecting or not selecting a signal waveform included in the drive signal COM will be described. FIG. 9 is a diagram illustrating a configuration of the drive signal selection circuit 200. As illustrated in FIG. 9, the drive signal selection circuit 200 includes a selection control circuit 210 and a plurality of selection circuits 230, while the number of selection circuits 230 is the same as the number of piezoelectric elements 60. In the following description, it is assumed that the print head 22 includes p piezoelectric elements 60. That is, the drive signal selection circuit 200 includes p selection circuits 230.

The clock signal SCK, the print data signal SI, the latch signal LAT, and the change signal CH are input to the selection control circuit 210. In addition, in the selection control circuit 210, a set of a shift register (S/R) 212, a latch circuit 214, and a decoder 216 is provided corresponding to each of the p piezoelectric elements 60. That is, the drive signal selection circuit 200 includes p shift registers 212, p latch circuits 214, and p decoders 216.

The print data signal SI is input to the selection control circuit 210 in synchronization with the clock signal SCK. The print data signal SI serially includes 2-bit print data [SIh, SIL] for selecting any one of a “large dot LD”, a “medium dot MD”, a “small dot SD”, and “non-recording ND”. The 2-bit print data [SIH, SIL] corresponds to each of the p piezoelectric elements 60. The print data [SIH, SIL] included in the print data signal SI is held in the p shift registers 212 corresponding to the p piezoelectric elements 60. Specifically, the p shift registers 212 corresponding to the piezoelectric elements 60 are cascaded to each other, and the print data signal SI input in serial is sequentially transferred to the shift registers 212 at the subsequent stages according to the clock signal SCK. The clock signal SCK is stopped when the print data [SIH, SIL] is held in the corresponding shift registers 212. As a result, the print data [SIH, SIL] included in the print data signal SI is held in the corresponding shift registers 212. In FIG. 9, in order to distinguish the p shift registers 212 from each other, stages at which the p shift registers 212 are disposed are denoted as the first stage, the second stage, - - - , and the p-th stage in order from the upstream side on which the print data signal SI is input.

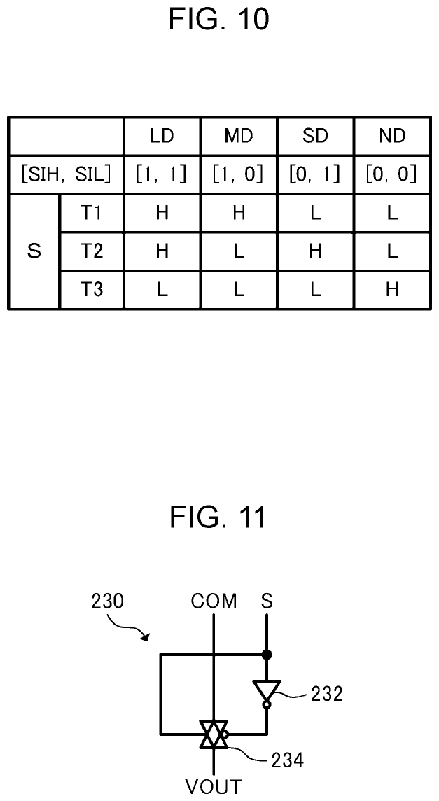

The p latch circuits 214 simultaneously latch the print data [SIH, SIL] held in the corresponding shift registers 212 at a rising edge of the latch signal LAT. Then, the print data [SIH, SIL] latched by the latch circuits 214 is input to the corresponding decoders 216. FIG. 10 is a table illustrating an example of the content of decoding by the decoders 216. Each of the decoders 216 outputs a selection signal S having a logic level defined by the input print data [SIH, SIL] in each of the periods t1, t2, and t3. For example, when the print data [SIH, SIL]=[1, 0] is input to the decoders 216, the decoders 216 output selection signals S having logic levels as H, L, and L levels in the periods t1, t2, and t3, respectively.

The selection signals S output by the decoders 216 are input to the selection circuits 230. The selection circuits 230 are provided corresponding to the respective p piezoelectric elements 60. That is, the drive signal selection circuit 200 includes p selection circuits 230, while the number of selection circuits 230 is the same as the number of the p piezoelectric elements 60. FIG. 11 is a diagram illustrating a configuration of the selection circuit 230. As illustrated in FIG. 11, each of the selection circuits 230 includes an inverter 232, which is a NOT circuit, and a transfer gate 234.

The selection signal S is input to a positive control terminal which is included in the transfer gate 234 and is not marked with a circle. The selection signal S is also input to a negative control terminal which is included in the transfer gate 234 and is marked with a circle after the logic level of the selection signal S is inverted by the inverter 232. The drive signal COM is supplied to an input terminal of the transfer gate 234. The transfer gate 234 electrically conducts between the input terminal and the output terminal when the selection signal S having the high level is input to the transfer gate 234, and does not electrically conduct between the input terminal and the output terminal when the selection signal S having the low level is input to the transfer gate 234. That is, the transfer gate 234 outputs a signal waveform included in the drive signal COM from the output terminal when the logic level of the selection signal S is the high level, and does not output a signal waveform included in the drive signal COM from the output terminal when the logic level of the selection signal S is the low level. Then, the drive signal selection circuit 200 outputs, as a drive signal VOUT, the signal output to the output terminal of the transfer gate 234 included in the selection circuit 230.

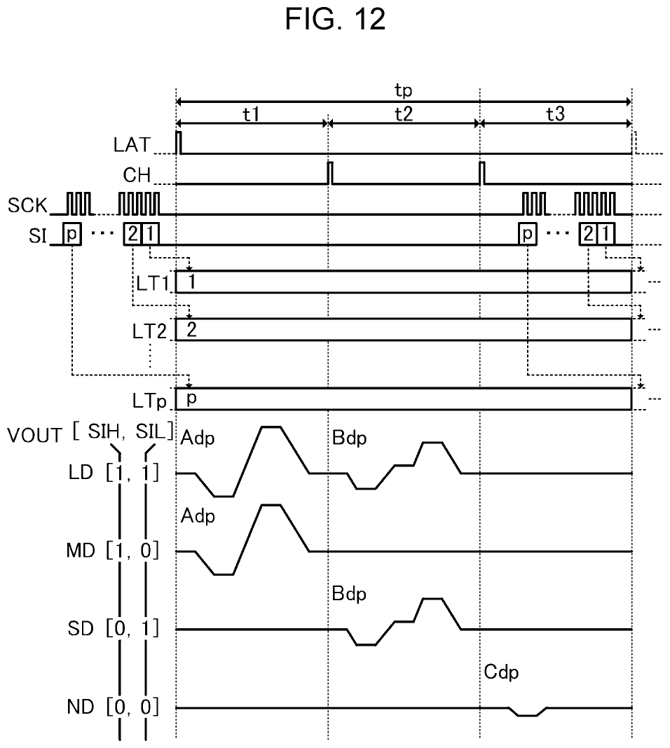

The operation of the drive signal selection circuit 200 will be described with reference to FIG. 12. FIG. 12 is a diagram for explaining the operation of the drive signal selection circuit 200. The print data signal SI is input to the selection control circuit 210 as a serial signal synchronized with the clock signal SCK. Then, the print data signal SI is sequentially transferred in the p shift registers 212 corresponding to the p piezoelectric elements 60 in synchronization with the clock signal SCK. Thereafter, when the input of the clock signal SCK is stopped, the print data [SIH, SIL] corresponding to the p piezoelectric elements 60 is held in the shift registers 212. In addition, the print data signal SI is input in order corresponding to the piezoelectric elements 60 at the p-th stage, - - - , the second stage, and the first stage of the shift registers 212.

When the latch signal LAT rises, the latch circuits 214 simultaneously latch the print data [SIH, SIL] held in the shift registers 212. LT1, LT2, - - - , and LTp illustrated in FIG. 12 indicate the print data [SIH, SIL] latched by the latch circuits 214 corresponding to the shift registers 212 at the first stage, the second stage, - - - , and the p-th stage, respectively.

The decoders 216 output selection signals S having logic levels with the content illustrated in FIG. 10 in each of the periods t1, t2, and t3 according to a dot size defined by the latched print data [SIH, SIL]. Then, the selection circuits 230 generate drive signals VOUT by selecting or not selecting a signal waveform included in the drive signal COM according to the logic levels of the selection signals S output by the decoders 216.

Specifically, when the print data [SIH, SIL]=[1, 1] is input to the decoder 216, the decoder 216 sets the logic level of the selection signal S to H, H, and L levels in the periods t1, t2, and t3, respectively. Accordingly, the selection circuit 230 selects the trapezoidal waveform Adp in the period t1, selects the trapezoidal waveform Bdp in the period t2, and does not select the trapezoidal waveform Cdp in the period t3. As a result, the drive signal selection circuit 200 outputs a drive signal VOUT corresponding to the “large dot LD”.

When the drive signal VOUT corresponding to the “large dot LD” is supplied to the piezoelectric element 60, the medium amount of ink is ejected in the period t1, the small amount of ink is ejected in the period t2, and no ink is ejected in the period t3. Then, the medium amount of ink ejected and the small amount of ink ejected land on the medium P and are combined with each other, and thus the “large dot LD” is formed on the medium P.

In addition, when the print data [SIH, SIL]=[1, 0] is input to the decoder 216, the decoder 216 sets the logic level of the selection signal S to H, L, and L levels in the periods t1, t2, and t3, respectively. Accordingly, the selection circuit 230 selects the trapezoidal waveform Adp in the period t1, does not select the trapezoidal waveform Bdp in the period t2, and does not select the trapezoidal waveform Cdp in the period t3. As a result, the drive signal selection circuit 200 outputs a drive signal VOUT corresponding to the “medium dot MD”.

When the drive signal VOUT corresponding to the “medium dot MD” is supplied to the piezoelectric element 60, the medium amount of ink is ejected in the period t1, ink is not ejected in the period t2, and ink is not ejected in the period t3. Then, the medium amount of ink ejected lands on the medium P, and thus the “medium dot MD” is formed on the medium P.

In addition, when the print data [SIH, SIL]=[0, 1] is input to the decoder 216, the decoder 216 sets the logic level of the selection signal S to L, H, and L levels in the periods t1, t2, and t3, respectively. Accordingly, the selection circuit 230 does not select the trapezoidal waveform Adp in the period t1, selects the trapezoidal waveform Bdp in the period t2, and does not select the trapezoidal waveform Cdp in the period t3. As a result, the drive signal selection circuit 200 outputs a drive signal VOUT corresponding to the “small dot SD”.

When the drive signal VOUT corresponding to the “small dot SD” is supplied to the piezoelectric element 60, ink is not ejected in the period t1, the small amount of ink is ejected in the period t2, and ink is not ejected in the period t3. The small amount of ink ejected lands on the medium P and thus the “small dot SD” is formed on the medium P.

In addition, when the print data [SIH, SIL]=[0,0] is input to the decoder 216, the decoder 216 sets the logic level of the selection signal S to L, L, and H levels in the periods t1, t2, and t3, respectively. Accordingly, the selection circuit 230 does not select the trapezoidal waveform Adp in the period t1, does not select the trapezoidal waveform Bdp in the period t2, and selects the trapezoidal waveform Cdp in the period t3. As a result, the drive signal selection circuit 200 outputs a drive signal VOUT corresponding to “non-recording ND”.

When the drive signal VOUT corresponding to “non-recording ND” is supplied to the piezoelectric element 60, ink is not ejected in the period t1, ink is not ejected in the period t2, and ink is not ejected in the period t3. Therefore, “non-recording ND” is set such that a dot is not formed on the medium P. In this case, the drive signal VOUT including the trapezoidal waveform Cdp is input to the corresponding piezoelectric element 60. Therefore, the minute vibration is executed. As a result, the possibility that the viscosity of the ink in the vicinity of the opening portion of the corresponding nozzle 321 may increase is reduced.

As described above, the drive signal selection circuit 200 generates drive signals VOUT by selecting or not selecting a signal waveform included in the drive signal COM output by the drive circuit 50, and outputs the drive signals VOUT to the corresponding piezoelectric elements 60. Therefore, each of the drive signals VOUT includes any one or two of the trapezoidal waveforms Adp, Bdp, and Cdp included in the drive signal COM output by the drive circuit 50. The print head 22 that ejects ink based on the drive signals VOUT can be regarded to eject ink based on the drive signal COM.

### 5. Configuration of Temperature Detection Circuit

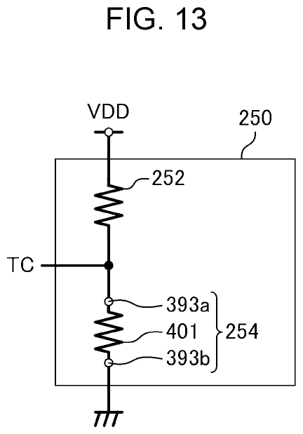

Next, a configuration of each of the temperature detection circuits 250 will be described. FIG. 13 is a diagram illustrating an example of the configuration of the temperature detection circuit 250. As illustrated in FIG. 13, the temperature detection circuit 250 includes resistors 252 and 254. The resistor 254 includes the resistance wiring 401 and the measurement lead electrodes 393a and 393b described above. That is, at least the resistor 254 of the temperature detection circuit 250 is disposed in the print head 22.

A voltage signal VDD having a constant voltage value is supplied to one end of the resistor 252. The other end of the resistor 252 is electrically coupled to the measurement lead electrode 393a that is one end of the resistor 254 and is included in the resistor 254. A ground electrical potential is supplied to the measurement lead electrode 393b that is the other end of the resistor 254 and is included in the resistor 254. Then, the temperature detection circuit 250 outputs, as a head temperature signal TC, a value of a voltage generated at a coupling point between the other end of the resistor 252 and the one end of the resistor 254. That is, the temperature detection circuit 250 outputs, as the head temperature signal TC, a signal of the voltage value obtained by dividing the voltage signal VDD by the resistance value of the resistor 252 and the resistance value of the resistance wiring 401.

As described above, the resistance value of the resistance wiring 401 changes according to the temperature of the print head 22, that is, the temperature of each of the pressure chambers 312. That is, the resistor 254 including the resistance wiring 401 functions as a thermistor element having a resistance value that changes depending on the temperature. Since the resistance value of the resistance wiring 401 changes according to the temperature of the print head 22, that is, the temperature of each of the pressure chambers 312, the voltage value of the head temperature signal TC to be output by the temperature detection circuit 250 also changes according to the temperature of the print head 22, that is, the temperature of each of the pressure chambers 312. That is, the temperature detection circuit 250 outputs the head temperature signal TC having a voltage value that changes according to the temperature of the print head 22, that is, the temperature of each of the pressure chambers 312.

In the temperature detection circuit 250 according to the present embodiment, the resistor 254 on the low electrical potential side out of the resistors 252 and 254 that divide the voltage signal VDD includes the resistance wiring 401 and the measurement lead electrodes 393a and 393b. However, the resistor 252 on the high electrical potential side may include the resistance wiring 401 and the measurement lead electrodes 393a and 393b. The temperature detection circuit 250 may include a plurality of resistance elements in addition to the resistors 252 and 254.

### 6. Configuration of Temperature Information Output Circuit

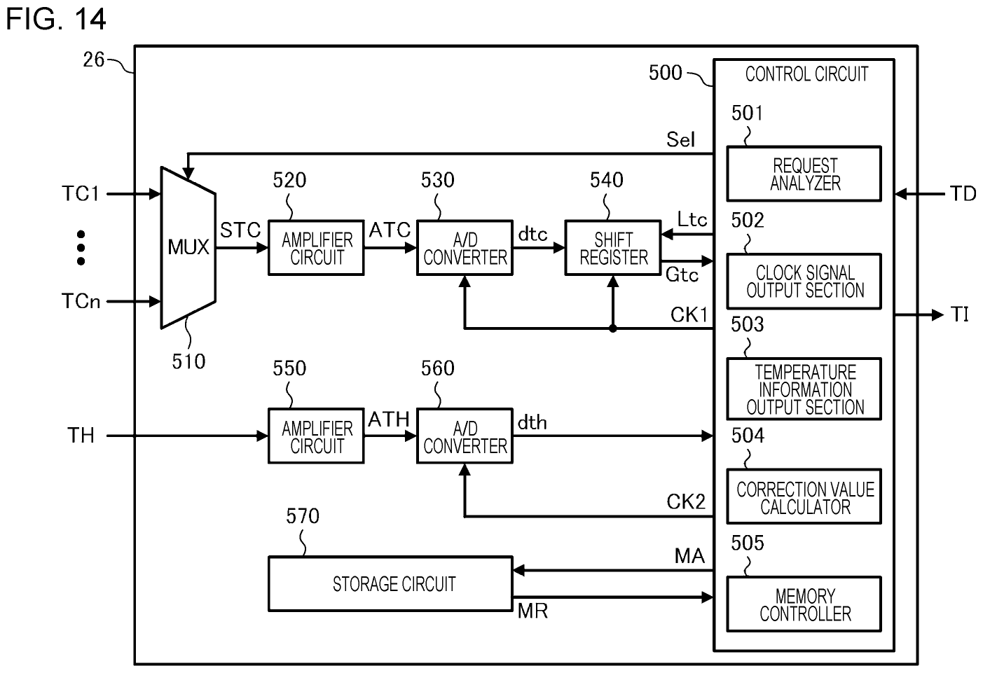

Next, the configuration and operation of the temperature information output circuit 26 will be described. FIG. 14 is a diagram illustrating an example of the configuration of the temperature information output circuit 26. The temperature information output circuit 26 acquires, based on the temperature acquisition request signal TD input from the control circuit 100, at least one of the head temperature signals TC1 to TCn input from the print heads 22-1 to 22-n, respectively, and the unit temperature signal TH input from the temperature detection circuit 28. Then, the temperature information output circuit 26 generates a temperature information signal TI corresponding to the temperature of the print head 22 based on the at least one of the acquired head temperature signals TC1 to TCn and the unit temperature signal TH, and outputs the temperature information signal TI to the control circuit 100.

As illustrated in FIG. 14, the temperature information output circuit 26 includes a control circuit 500, a multiplexer 510, amplifier circuits 520 and 550, A/D converters 530 and 560, a shift register 540, and a storage circuit 570.

The head temperature signals TC1 to TCn output by the print heads 22-1 to 22-n, respectively, are input to the multiplexer 510. A select signal Sel output by the control circuit 500 is also input to the multiplexer 510. The multiplexer 510 selects any one of the head temperature signals TC1 to TCn according to the input select signal Sel and outputs the selected signal as a selected temperature signal STC.

The selected temperature signal STC output by the multiplexer 510 is input to the amplifier circuit 520. The amplifier circuit 520 generates an amplified head temperature signal ATC by amplifying a voltage value of the input selected temperature signal STC and outputs the generated amplified head temperature signal ATC.

The amplified head temperature signal ATC output by the amplifier circuit 520 and a clock signal CK1 output by the control circuit 500 are input to the A/D converter 530. The A/D converter 530 acquires a voltage value of the amplified head temperature signal ATC in synchronization with the clock signal CK1, generates a digital signal corresponding to the acquired voltage value, and outputs the generated digital signal to the shift register 540 as a piece of digital temperature information dtc. That is, the A/D converter 530 generates the piece of digital temperature information dtc corresponding to the voltage value of the signal obtained by amplifying the head temperature signal TC selected by the multiplexer 510 by the amplifier circuit 520, that is, the A/D converter 530 generates the piece of digital temperature information dtc corresponding to the temperature of the print head 22 corresponding to the head temperature signal TC selected by the multiplexer 510. Then, the A/D converter 530 outputs the piece of digital temperature information dtc to the shift register 540.

In the following description, it is assumed that the A/D converter 530 outputs, to the shift register 540, a piece of digital temperature information dtc obtained by converting the amplified head temperature signal ATC input at a rising edge of the clock signal CK1 into a digital signal, but the A/D converter 530 may output, to the shift register 540, a piece of digital temperature information dtc obtained by converting the amplified head temperature signal ATC input at a falling edge of the clock signal CK1 into a digital signal.

The piece of digital temperature information dtc output by the A/D converter 530 and the clock signal CK1 are input to the shift register 540. The shift register 540 sequentially acquires and holds input pieces of digital temperature information dtc at timings synchronized with the clock signal CK1. That is, the shift register 540 sequentially acquires and holds the pieces of digital temperature information dtc output by the A/D converter 530 in synchronization with the timings at which the A/D converter 530 converts the amplified head temperature signal ATC into a digital signal.

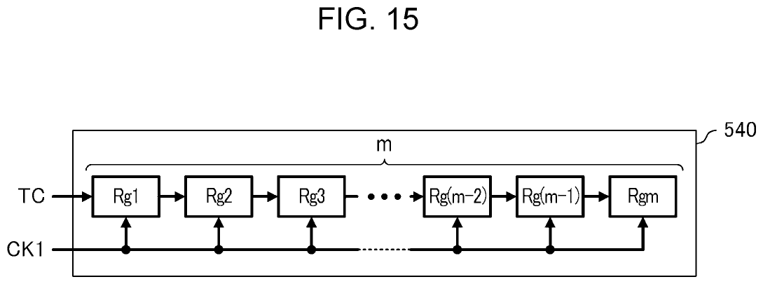

An example of the configuration and operation of the shift register 540 will be described. FIG. 15 is a diagram illustrating an example of the configuration of the shift register 540.

As illustrated in FIG. 15, the shift register 540 includes registers Rg1 to Rgm. The piece of digital temperature information dtc is input to an input terminal of the register Rg1. An output terminal of the register Rg1 is electrically coupled to an input terminal of the register Rg2. An output terminal of the register Rg2 is electrically coupled to an input terminal of the register Rg3. Similarly, an input terminal of the register Rgj (j is any one of 2 to m−1) is electrically coupled to an output terminal of the register Rg(j−1), and an output terminal of the register Rgj is electrically coupled to an input terminal of the register Rg(j+1). An output terminal of the register Rgm may be open or may be electrically coupled to the ground via a resistance element or the like. That is, the registers Rg1 to Rgm included in the shift register 540 are serially coupled in the order of the register Rg1, the register Rg2, - - - , the register Rg(m−1), and the register Rgm as viewed from the side on which the piece of digital temperature information dtc is input. In the following description, when it is not necessary to distinguish the registers Rg1 to Rgm, the registers Rg1 to Rgm may be simply referred to as registers Rg. That is, the shift register 540 includes the m registers Rg coupled in series.

The clock signal CK1 is input to each of the registers Rg1 to Rgm. Each of the registers Rg1 to Rgm acquires and holds information of the input terminal at a falling edge of the input clock signal CK1, and outputs the held information from the output terminal at a rising edge of the input clock signal CK1. Each of the registers Rg1 to Rgm may acquire and hold information of the input terminal at a rising edge of the input clock signal CK1, and may output the held information at a falling edge of the input clock signal CK1.

An example of the operation of the shift register 540 configured as described above will be described.

The A/D converter 530 outputs the piece of digital temperature information dtc corresponding to the temperature of the print head 22 corresponding to the head temperature signal TC selected by the multiplexer 510 at a rising edge of the clock signal CK1. Accordingly, the piece of digital temperature information dtc output by the A/D converter 530 at the rising edge of the clock signal CK1 is input to the input terminal of the register Rg1. Further, at the rising edge of the clock signal CK1, each of the registers Rg1 to Rgm outputs the held information from the output terminal. Accordingly, the information held in the register Rg1 is input to the input terminal of the register Rg2, and the information held in the register Rg(j−1) is input to the input terminal of the register Rgj.

Then, at a subsequent falling edge of the clock signal CK1, each of the registers Rg1 to Rgm holds the information of the input terminal. That is, at the falling edge of the clock signal CK1, the register Rg1 holds the piece of digital temperature information dtc output by the A/D converter 530 at the immediately preceding rising edge of the clock signal CK1, the register Rg2 holds the information output by the register Rg1 at the immediately preceding rising edge of the clock signal CK1, the register Rgj holds the information output by the register Rg(j−1) at the immediately preceding rising edge of the clock signal CK1, and the register Rgm holds the information output by the register Rg(m−1) at the immediately preceding rising edge of the clock signal CK1.

That is, each time the clock signal CK1 rises, the A/D converter 530 outputs a piece of digital temperature information dtc corresponding to the temperature of the print head 22 corresponding to the head temperature signal TC selected by the multiplexer 510. Each time the clock signal CK1 rises, the shift register 540 transfers information held in each of the registers Rg1 to Rg(n−1) to the register Rg at the subsequent stage. Each time the clock signal CK1 falls, the register Rg1 of the shift register 540 acquires and holds a piece of digital temperature information dtc output by the A/D converter 530, and each of the registers Rg2 to Rgm acquires and holds information of the input terminal. The shift register 540 acquires and holds a piece of digital temperature information dtc input each time the clock signal CK1 rises, and transfers the piece of held digital temperature information dtc to the register Rg at the subsequent stage. Therefore, the shift register 540 holds m pieces of digital temperature information dtc by a so-called first in first out (FIFO) method in which each time the clock signal CK1 rises, the shift register 540 holds an input piece of digital temperature information dtc and discards the oldest piece of information included in held digital temperature information dtc.

Specifically, the shift register 540 holds, in the register Rg1, a piece of digital temperature information dtc most recently output by the A/D converter 530, holds, in the register Rg(j+1), a piece of digital temperature information dtc output by the A/D converter 530 j periods before the latest period of the clock signal CK1, and holds, in the register Rgm, a piece of digital temperature information dtc output by the A/D converter 530 (m−1) periods before the latest period of the clock signal CK1.

In the following description, the m pieces of digital temperature information dtc held by the m registers Rg included in the shift register 540 may be referred to as m pieces of held temperature information dtr. When the m pieces of held temperature information dtr held in the m registers Rg are distinguished from each other, the piece of digital temperature information dtc held in the register Rg1 is referred to as a piece of held temperature information dtr1, the piece of digital temperature information dtc held in the register Rgj is referred to as a piece of held temperature information dtrj, and the piece of digital temperature information dtc held in the register Rgm is referred to as a piece of held temperature information dtrm.

Returning to FIG. 14, a read request signal Ltc output by the control circuit 500 is input to the shift register 540. The shift register 540 outputs, based on the input read request signal Ltc, a held temperature information group Gtc including the m pieces of held temperature information dtr, which are m pieces of held digital temperature information dtc, to the control circuit 500.

The unit temperature signal TH output by the temperature detection circuit 28 is input to the amplifier circuit 550. The amplifier circuit 520 generates an amplified unit temperature signal ATH by amplifying a voltage value of the input unit temperature signal TH and outputs the generated amplified unit temperature signal ATH.

The amplified unit temperature signal ATH output by the amplification circuit 520 and a clock signal CK2 output by the control circuit 500 are input to the A/D converter 560. The A/D converter 560 acquires a voltage value of the amplified unit temperature signal ATH, generates a digital signal corresponding to the acquired voltage value, and outputs the generated digital signal to the control circuit 500 as digital temperature information dth in synchronization with the clock signal CK2. That is, the A/D converter 560 generates the digital temperature information dth corresponding to the temperature detected by the temperature detection circuit 28 and outputs the digital temperature information dth to the control circuit 500 at a timing synchronized with the clock signal CK2.

The control circuit 500 includes a request analyzer 501, a clock signal output section 502, a temperature information output section 503, a correction value calculator 504, and a memory controller 505. The temperature acquisition request signal TD is input to the control circuit 500. Then, the control circuit 500 outputs the select signal Sel, the clock signals CK1 and CK2, and the read request signal Ltc according to the input temperature acquisition request signal TD. As a result, the control circuit 500 controls operations of the various components included in the temperature information output circuit 26. The held temperature information group Gtc including the m pieces of held temperature information dtr is input to the control circuit 500. The control circuit 500 generates the temperature information signal TI based on the m pieces of held temperature information dtr included in the input held temperature information group Gtc, and outputs the temperature information signal TI from the temperature information output circuit 26.

An example of an operation of each component of the control circuit 500 will be described.

The request analyzer 501 acquires and analyzes the temperature acquisition request signal TD input to the control circuit 500. The control circuit 500 generates the select signal Sel and the read request signal Ltc according to a result of the analysis by the request analyzer 501, and outputs the generated select signal Sel and the generated read request signal Ltc at a timing according to the result of the analysis by the request analyzer 501. The select signal Sel and the read request signal Ltc output by the control circuit 500 are supplied to the corresponding components of the temperature information output circuit 26, whereby the temperature information output circuit 26 operates.

The clock signal output section 502 generates and outputs the clock signals CK1 and CK2 by dividing or multiplying an oscillation signal output by an oscillation circuit (not illustrated). In this case, whether or not the clock signal output section 502 outputs the clock signals CK1 and CK2 may be controlled according to the result of analyzing the temperature acquisition request signal TD in the request analyzer 501, and the outputting of the clock signals CK1 and CK2 may be continued regardless of the result of analyzing the temperature acquisition request signal TD in the request analyzer 501.

The temperature information output section 503 acquires the input held temperature information group Gtc based on the read request signal Ltc output by the control circuit 500. Then, the temperature information output section 503 generates the temperature information signal TI based on the m pieces of held temperature information dtr included in the acquired held temperature information group Gtc. The control circuit 500 outputs the temperature information signal TI generated by the temperature information output section 503 to the control circuit 100. That is, the temperature information output section 503 generates the temperature information signal TI that corresponds to the voltage value of the head temperature signal TC output by the print head 22 and corresponds to the temperature of the print head 22, and outputs the temperature information signal TI to the control circuit 100.

The correction value calculator 504 calculates a correction value Cv for correcting the temperature information signal TI to be output by the control circuit 500. For example, the correction value calculator 504 acquires the held temperature information group Gtc including the m pieces of held temperature information dtr and the digital temperature information dth at a predetermined timing after the temperature acquisition request signal TD including a request to calculate the correction value Cv is input from the control circuit 100, and calculates the correction value Cv based on the acquired held temperature information group Gtc and the acquired digital temperature information dth.

Specifically, the correction value calculator 504 acquires the held temperature information group Gtc including the m pieces of held temperature information dtr corresponding to the head temperature signal TC1 output by the print head 22-1 and the digital temperature information dth at the predetermined timing after the temperature acquisition request signal TD is input, and calculates the correction value Cv corresponding to the print head 22-1 based on a difference between the acquired m pieces of held temperature information dtr and the acquired digital temperature information dth. Similarly, the correction value calculator 504 acquires a held temperature information group Gtc including m pieces of held temperature information dtr corresponding to a head temperature signal TCi output by the print head 22-i and the digital temperature information dth at a predetermined timing after the temperature acquisition request signal TD is input, and calculates a correction value Cv corresponding to the print head 22-i based on a difference between the acquired m pieces of held temperature information dtr and the digital temperature information dth. That is, the correction value calculator 504 calculates n correction values Cv corresponding to the respective print heads 22-1 to 22-n. The temperature information output section 503 corrects the m pieces of held temperature information dtr included in the acquired held temperature information group Gtc by using each of the correction values Cv calculated by the correction value calculator 504, and generates the temperature information signal TI based on the corrected m pieces of held temperature information dtr.

The memory controller 505 generates a memory control signal MA for accessing the storage circuit 570, outputs the memory control signal MA to the storage circuit 570, and acquires a memory read signal MR output by the storage circuit 570 in response to the memory control signal MA. Specifically, the storage circuit 570 stores various kinds of information including the n correction values Cv described above. The memory controller 505 generates a memory control signal MA for storing information such as the correction values Cv, outputs the memory control signal MA to the storage circuit 570, generates a memory control signal MA for reading the information such as the correction values Cv stored in the storage circuit 570, and outputs the memory control signal MA to the storage circuit 570.

The storage circuit 570 stores various kinds of information including the correction values Cv in response to the input memory control signals MA, reads the information such as the correction values Cv, and outputs a memory read signal MR including the read information to the control circuit 500. The storage circuit 570 includes a nonvolatile memory such as a ROM or a flash memory.

As described above, the temperature information output circuit 26 includes the multiplexer 510 that selects a head temperature signal TC from among the head temperature signals TC1 to TCn, the amplifier circuit 520 that outputs the amplified head temperature signal ATC which is the head temperature signal TC selected by the multiplexer 510 and has been obtained by amplifying the selected temperature signal STC, and the A/D converter 530 that acquires the amplified head temperature signal ATC at each of predetermined sampling periods defined by the clock signal CK1 and converts the acquired amplified head temperature signal ATC into pieces of digital temperature information dtc. The temperature information output circuit 26 acquires the head temperature signal TC corresponding to the temperature of the print head 22 at the predetermined sampling periods defined by the clock signal CK1, and outputs the temperature information signal TI corresponding to the acquired head temperature signal TC.

The temperature information output circuit 26 is preferably configured as, for example, an integrated circuit. Accordingly, it is possible to reduce the mounting area of the temperature information output circuit 26 in the head unit 20, and as a result, it is possible to miniaturize the head unit 20. In this case, the number of integrated circuits constituting the temperature information output circuit 26 is not limited to one, and a plurality of integrated circuits may be disposed as the temperature information output circuit 26. Of course, the temperature information output circuit 26 may include a plurality of circuit elements in addition to the integrated circuit.

### 7. Operation and Timing of Detecting Temperature in Temperature Information Output Circuit

In the liquid ejecting apparatus 1 and the head unit 20, physical properties such as the viscosity of the ink to be ejected from the nozzles 321 change depending on the temperature. Such a change in the physical properties of the ink greatly contributes to the accuracy of ejecting the ink. Therefore, in the liquid ejecting apparatus 1 and the head unit 20, the acquisition of the temperature of the ink which is to be ejected from the nozzles 321 and is stored in the pressure chambers 312 communicating with the nozzles 321, and the correction of various signals for controlling the operations of the liquid ejecting apparatus 1 and the head unit 20 according to the acquired temperature of the ink reduce the possibility that the accuracy of ejecting the ink may decrease even when the temperature of the ink changes.

In particular, in the liquid ejecting apparatus 1 and the head unit 20 according to the present embodiment, the temperature detection circuit 250 that detects the temperature of the print head 22 includes the resistance wiring 401 in which the resistance value changes according to the temperature, the resistance wiring 401 is located in the vicinities of the pressure chambers 312, and the vibration plate 350 that seals the openings of the surface of the pressure chamber substrate 310 on the +Z side is formed on the pressure chamber substrate 310 in which the pressure chambers 312 are formed. Therefore, the temperature detection circuit 250 can detect, in the vicinities of the pressure chambers 312, the temperature of the ink stored in the pressure chambers 312, and can more accurately detect the temperature of the ink stored in the pressure chambers 312. As a result, in the liquid ejecting apparatus 1 and the head unit 20 according to the present embodiment, it is possible to more appropriately correct various signals for controlling the operations of the liquid ejecting apparatus 1 and the head unit 20 according to the temperature of the ink stored in the pressure chambers 312, and even when the temperature of the ink changes, it is possible to further reduce the possibility that the accuracy of ejecting the ink may decrease.

On the other hand, since the resistance wiring 401 included in the temperature detection circuit 250 is disposed in the vicinities of the pressure chambers 312 in which the ink is stored, the following problem may occur.

From the viewpoint of improving the quality of an image formed on the medium P, several hundred or more nozzles 321 are arranged at a high density in each of the print heads 22. Therefore, each of the print heads 22 has several hundred or more piezoelectric elements 60 corresponding to the several hundred or more nozzles 321, and the several hundred or more piezoelectric elements 60 are arranged on the vibration plate 350 at a high density. Therefore, in each of the print heads 22, signal wiring through which a drive signal VOUT to be supplied to each piezoelectric element 60 propagates is densely arranged on the vibration plate 350. When the resistance wiring 401 is disposed on the vibration plate 350, the resistance wiring 401 is disposed in the vicinity of the signal wiring through which the drive signal VOUT propagates, and the possibility that noise generated due to a change in a voltage value of a drive signal VOUT may contribute to the resistance wiring 401 increases. If noise generated due to a change in the voltage of the drive signal VOUT contributes to the resistance wiring 401, the accuracy of the head temperature signal TC output by the temperature detection circuit 250 including the resistance wiring 401 decreases, and the accuracy of detecting the temperatures of the pressure chambers 312 decreases.

In addition, when the piezoelectric elements 60 are driven by the drive signals VOUT, the vibration plate 350 on which the resistance wiring 401 is disposed deforms according to the driving of the piezoelectric elements 60. Along with the deformation of the vibration plate 350, the impedance of the resistance wiring 401 disposed on the vibration plate 350 may change. If the impedance of the resistance wiring 401 disposed on the vibration plate 350 changes, the accuracy of the head temperature signal TC output by the temperature detection circuit 250 including the resistance wiring 401 decreases, and the accuracy of detecting the temperatures of the pressure chambers 312 decreases.

Further, as described above, the print head 22 applies pressure to the ink stored in the pressure chambers 312 due to changes in the volumes of the pressure chambers 312, and ejects the ink from the nozzles 321. In the print head 22 having the structure, there is a possibility that the temperature of the ink stored in the pressure chambers 312 instantaneously changes due to a change in the pressure in the pressure chambers 312 that occurs when the ink is ejected. When the temperature detection circuit 250 including the resistance wiring 401 detects the change in the temperature that instantaneously occurs, the change in the temperature may be superimposed as noise on the head temperature signal TC output by the temperature detection circuit 250. If an instantaneous change in the temperature of the ink stored in the pressure chambers 312 is superimposed on the head temperature signal TC as noise, the accuracy of the head temperature signal TC output by the temperature detection circuit 250 decreases, and the accuracy of detecting the temperatures of the pressure chambers 312 decreases.

To solve the problems, in the liquid ejecting apparatus 1 according to the present embodiment, the temperature information output circuit 26 generates the temperature information signal TI corresponding to the temperature of the print head 22 using the head temperature signal TC acquired at the optimal timing and outputs the temperature information signal TI to the control circuit 100, thereby reducing the possibility that the accuracy of detecting the temperatures of the pressure chambers 312 by the temperature detection circuit 250 including the resistance wiring 401 may decrease.

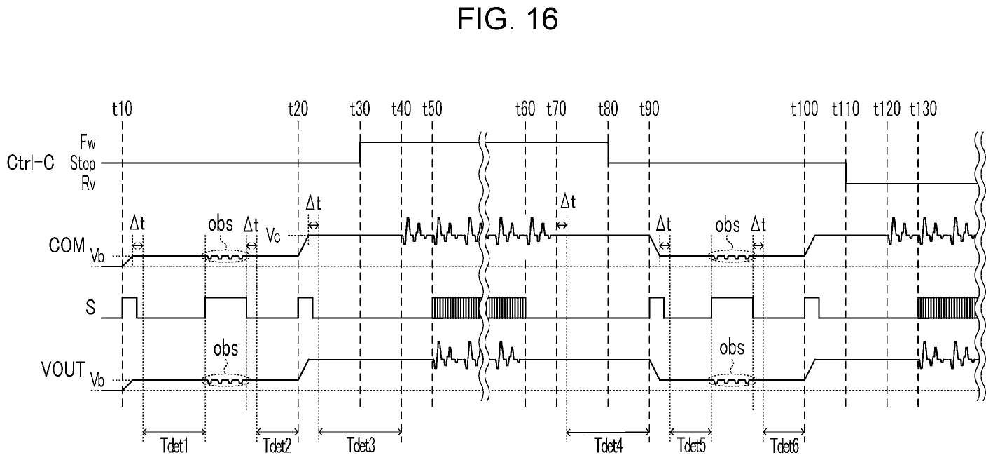

FIG. 16 is a diagram illustrating an example of the timing of acquiring the temperature of the print head 22. An example of an operation of the liquid ejecting apparatus 1 will be described before description of the timing of acquiring the temperature of the print head 22, and an example of the timing of acquiring the temperature of the print head 22 will be described.

As illustrated in FIG. 16, the liquid ejecting apparatus 1 is started when a power supply voltage is supplied to the liquid ejecting apparatus 1 at time t10. When the liquid ejecting apparatus 1 is started, the drive circuit 50 starts outputting, as the drive signal COM, a signal in which a voltage value is constant at the voltage Vb.

In addition, at the time t10 when the liquid ejecting apparatus 1 is started and the drive circuit 50 starts outputting the drive signal COM in which the voltage value is constant at the voltage Vb, the control circuit 100 outputs the print data signal SI for controlling the logic level of the selection signal S to the H level in order to control all of the selection circuits 230 to be conductive. Accordingly, a drive signal VOUT which is based on the drive signal COM output by the drive circuit 50 and in which a voltage value changes toward the voltage Vb is supplied to each of the electrodes 360 of the plurality of piezoelectric elements 60 included in the print head 22. Thereafter, when the voltage value of the drive signal COM output by the drive circuit 50 becomes constant at the voltage Vb, the drive signal VOUT in which the voltage value is constant at the voltage Vb is supplied to each of the electrodes 360 of the piezoelectric elements 60. In this case, the voltage Vb is preferably substantially equal to the voltage value of the reference voltage signal VBS. Accordingly, the possibility that the piezoelectric elements 60 may deform in an unintended manner decreases, and the possibility that an abnormality such as a crack may occur in the piezoelectric elements 60 decreases.

After the voltage value of the drive signal VOUT supplied to each of the electrodes 360 of the piezoelectric elements 60 becomes constant at the voltage Vb, the control circuit 100 outputs the print data signal SI for controlling the logic level of the selection signal S to the L level in order to control all of the selection circuits 230 to be non-conductive. Thus, the selection circuits 230 are controlled to be non-conductive. In this case, the voltage values of the electrodes 360 of the piezoelectric elements 60 are held at the voltage Vb in capacitance components of the piezoelectric elements 60. Thereafter, the liquid ejecting apparatus 1 waits for a period until an image information signal including image data or the like is input to the liquid ejecting apparatus 1 from the external apparatus such as the host computer in a state where the drive circuit 50 continues to output the drive signal COM in which the voltage value is constant at the voltage Vb.

In addition, the drive circuit 50 outputs a signal including a minute vibration waveform obs as the drive signal COM at a predetermined timing in a waiting period in which the liquid ejecting apparatus 1 waits for the input of the image information signal. The minute vibration waveform obs is a signal waveform in which a voltage value starts at the voltage Vb and ends at the voltage Vb, and is provided for executing minute vibration for preventing an increase in the viscosity of the ink by vibrating the ink in the vicinities of the opening portions of the corresponding nozzles, similarly to the trapezoidal waveform Cdp described above. The shape of the minute vibration waveform obs may be the same as that of the trapezoidal waveform Cdp described above, or may be different from that of the trapezoidal waveform Cdp.

In addition, when the drive circuit 50 outputs the drive signal COM including the minute vibration waveform obs, the control circuit 100 outputs the print data signal SI for controlling the logic level of the selection signal S to the H level in order to control all of the selection circuits 230 to be conductive. Thus, a drive signal VOUT including the minute vibration waveform obs is supplied to each of the electrodes 360 of the piezoelectric elements 60. As a result, in the waiting period, the possibility that the ink may be fixed in the vicinities of the nozzles 321 decreases, and the possibility that the viscosity of the ink in the vicinities of the nozzles 321 may increase decreases. The drive signal VOUT including the minute vibration waveform obs may not be supplied to all of the piezoelectric elements 60 included in the print head 22, and may be supplied to only some of the piezoelectric elements 60 included in the print head 22. Further, the minute vibration may be executed based on the drive signal VOUT including the minute vibration waveform obs a plurality of times in the waiting period.

At time t20, when an image information signal is input from the external apparatus, the drive circuit 50 starts outputting, as the drive signal COM, a signal in which a voltage value is constant at the voltage Vc. In addition, at the time t20 when the drive circuit 50 starts outputting the drive signal COM in which the voltage value is constant at the voltage Vc, the control circuit 100 outputs the print data signal SI for controlling the logic level of the selection signal S to the H level in order to control all of the selection circuits 230 to be conductive. Accordingly, a drive signal VOUT which is based on the drive signal COM output by the drive circuit 50 and in which a voltage value changes toward the voltage Vc is supplied to each of the electrodes 360 of the plurality of piezoelectric elements 60 included in the print head 22. Thereafter, when the voltage value of the drive signal COM output by the drive circuit 50 becomes constant at the voltage Vc, the drive signal VOUT in which the voltage value is constant at the voltage Vc is supplied to each of the electrodes 360 of the piezoelectric elements 60.

When the voltage value of the drive signal COM output by the drive circuit 50, that is, the voltage value of each of the electrodes 360 of the piezoelectric elements 60 becomes the voltage Vc, the control circuit 100 outputs the print data signal SI for controlling the logic level of the selection signal S to the L level in order to control all of the selection circuits 230 to be non-conductive. Thus, the selection circuits 230 are controlled to be non-conductive. In this case, the voltage values of the electrodes 360 of the piezoelectric elements 60 are held at the voltage Vc in the capacitance components of the piezoelectric elements 60.

At time t30 after the voltage value of the drive signal COM output by the drive circuit 50 becomes constant at the voltage Vc, the control circuit 100 outputs the control signal Ctrl-C for moving the carriage 21 on which the print heads 22 are mounted in the forward direction Fw along the scanning axis. Accordingly, the movement of the carriage 21 in the forward direction Fw along the scanning axis is started.

At time t40 after the movement of the carriage 21 in the forward direction Fw along the scanning axis is started, the drive circuit 50 starts outputting the drive signal COM in which the trapezoidal waveforms Adp, Bdp, and Cdp are continuous. Thereafter, at time t50, when the scanning position of the carriage 21 reaches a printing region where an image is to be formed on the medium P, the control circuit 100 outputs the print data signal SI and the clock signal SCK corresponding to the image information signal input from the external apparatus, and outputs the change signal CH and the latch signal LAT corresponding to the scanning position of the carriage 21. Accordingly, the selection control circuit 210 outputs a selection signal S having a logic level corresponding to each of the plurality of piezoelectric elements 60, and each of the selection circuits 230 outputs a drive signal VOUT based on the drive signal COM. Thus, a desired image is formed on the medium P. That is, the printing process is executed. The printing region is a region where the print head 22 can eject ink onto the medium P, and includes a region where at least a portion of the print head 22 is located to face the medium P in the ejection direction in which the ink is ejected.

At time t60, when the printing process in the forward direction Fw along the scanning axis is completed, the control circuit 100 outputs the print data signal SI for controlling the logic level of the selection signal S to the L level in order to control all of the selection circuits 230 to be non-conductive. Thus, the selection circuits 230 are controlled to be non-conductive. In this case, the voltage values of the electrodes 360 of the piezoelectric elements 60 are held at the voltage Vc in the capacitance components of the piezoelectric elements 60. Thereafter, at time t70, the drive circuit 50 stops outputting the drive signal COM in which the trapezoidal waveforms Adp, Bdp, and Cdp are continuous, and starts outputting the drive signal COM in which the voltage value is constant at the voltage Vc.

At time t80 after the voltage value of the drive signal COM output by the drive circuit 50 becomes constant at the voltage Vc, when the scanning position of the carriage 21 reaches a stop region, the control circuit 100 outputs the control signal Ctrl-C for stopping the carriage 21 on which the print heads 22 are mounted. As a result, the carriage 21 stops.

At time t90 after the carriage 21 stops, the drive circuit 50 starts outputting the drive signal COM in which the voltage value is constant at the voltage Vb. In addition, at the time t90 when the drive circuit 50 starts outputting the drive signal COM in which the voltage value is constant at the voltage Vb, the control circuit 100 outputs the print data signal SI for controlling the logic level of the selection signal S to the H level in order to control all of the selection circuits 230 to be conductive. Accordingly, a drive signal VOUT which is based on the drive signal COM output by the drive circuit 50 and in which a voltage value changes toward the voltage Vb is supplied to each of the electrodes 360 of the plurality of piezoelectric elements 60 included in the print head 22.

After the voltage value of the drive signal VOUT supplied to each of the electrodes 360 of the piezoelectric elements 60 becomes constant at the voltage Vb, the control circuit 100 outputs the print data signal SI for controlling the logic level of the selection signal S to the L level in order to control all of the selection circuits 230 to be non-conductive. Thus, the selection circuits 230 are controlled to be non-conductive. In this case, the voltage values of the electrodes 360 of the piezoelectric elements 60 are held at the voltage Vb in the capacitance components of the piezoelectric elements 60. Thereafter, the liquid ejecting apparatus 1 waits for a period until reversal processing of reversing the scanning direction of the carriage 21 is completed in a state where the drive circuit 50 continues to output the drive signal COM in which the voltage value is constant at the voltage Vb.

In addition, the drive circuit 50 outputs the drive signal COM including the minute vibration waveform obs at a predetermined timing in the waiting period until the reversal processing of the scanning direction of the carriage 21 is completed. In this case, the control circuit 100 outputs the print data signal SI for controlling the logic level of the selection signal S to the H level in order to control all of the selection circuits 230 to be conductive. Thus, the drive signal VOUT including the minute vibration waveform obs is supplied to each of the electrodes 360 of the piezoelectric elements 60. As a result, in the waiting period, the possibility that the ink may be fixed in the vicinities of the nozzles 321 decreases, and the possibility that the viscosity of the ink in the vicinities of the nozzles 321 may increase decreases. The drive signal VOUT including the minute vibration waveform obs may not be supplied to all of the piezoelectric elements 60 included in the print head 22, and may be supplied to only some of the piezoelectric elements 60 included in the print head 22. Further, the minute vibration may be executed based on the drive signal VOUT including the minute vibration waveform obs a plurality of times in the waiting period.

At time t100, when the reversal processing of reversing the scanning direction of the carriage 21 is completed, the drive circuit 50 starts outputting a signal in which a voltage value is constant at the voltage Vc as the drive signal COM. In addition, at the time t100 when the drive circuit 50 starts outputting the drive signal COM in which the voltage value is constant at the voltage Vc, the control circuit 100 outputs the print data signal SI for controlling the logic level of the selection signal S to the H level in order to control all of the selection circuits 230 to be conductive. Accordingly, a drive signal VOUT which is based on the drive signal COM output by the drive circuit 50 and in which a voltage value changes toward the voltage Vc is supplied to each of the electrodes 360 of the plurality of piezoelectric elements 60 included in the print head 22. Thereafter, when the voltage value of the drive signal COM output by the drive circuit 50 becomes constant at the voltage Vc, the drive signal VOUT in which the voltage value is the voltage Vc is supplied to each of the electrodes 360 of the piezoelectric elements 60.

Thereafter, the control circuit 100 outputs the print data signal SI for controlling the logic level of the selection signal S to the L level in order to control all of the selection circuits 230 to be non-conductive. Thus, the selection circuits 230 are controlled to be non-conductive. In this case, the voltage values of the electrodes 360 of the piezoelectric elements 60 are held at the voltage Vc in the capacitance components of the piezoelectric elements 60.

At time t110 after the voltage value of the drive signal COM output by the drive circuit 50 becomes constant at the voltage Vc, the control circuit 100 outputs the control signal Ctrl-C for moving the carriage 21 on which the print heads 22 are mounted in the reverse direction Rv along the scanning axis. Accordingly, the movement of the carriage 21 in the reverse direction Rv along the scanning axis is started.

At time t120 after the movement of the carriage 21 in the reverse direction Rv along the scanning axis is started, the drive circuit 50 starts outputting the drive signal COM in which the trapezoidal waveforms Adp, Bdp, and Cdp are continuous. Thereafter, at time t130, the scanning position of the carriage 21 on which the print heads 22 are mounted reaches the printing region where an image is to be formed on the medium P, and the control circuit 100 outputs the print data signal SI and the clock signal SCK corresponding to the image information signal input from the external apparatus, and outputs the change signal CH and the latch signal LAT corresponding to the scanning position of the carriage 21. Accordingly, each of the selection control circuits 210 outputs a selection signal S having a logic level corresponding to the print data signal SI, and each of the selection circuits 230 outputs a drive signal VOUT based on the drive signal COM. Thus, a desired image is formed on the medium P. That is, the printing process is executed.

In a period from the time t10 to the time t20 illustrated in FIG. 16, the liquid ejecting apparatus 1 waits for input of an image information signal from the external apparatus. An operation mode in which the liquid ejecting apparatus 1 waits for the input of the image information signal from the external apparatus may be referred to as a printing process standby mode. In addition, in a period from the time t20 to the time t90 illustrated in FIG. 16, the liquid ejecting apparatus 1 executes the printing process based on the image information signal. An operation mode in which the liquid ejecting apparatus 1 executes the printing process may be referred to as a printing process mode. In addition, in a period from the time t90 to the time t100 illustrated in FIG. 16, the liquid ejecting apparatus 1 waits until the reversal processing of reversing the scanning direction of the carriage 21 is completed. An operation mode in which the liquid ejecting apparatus 1 waits for the reversal processing of reversing the scanning direction of the carriage 21 may be referred to as a reversal processing standby mode.

Further, the same processing is executed at the time t20 and the time t100 illustrated in FIG. 16 except that the scanning directions of the carriage 21 are different at the time t20 and the time t100, the same processing is executed at the time t30 and the time t110 except that the scanning directions of the carriage 21 are different at the time t30 and the time t110, the same processing is executed at the time t40 and the time t120 except that the scanning directions of the carriage 21 are different at the time t40 and the time t120, and the same processing is executed at the time t50 and the time t130 except that the scanning directions of the carriage 21 are different at the time t50 and the time t130. That is, the liquid ejecting apparatus 1 forms a desired image on the medium P by repeatedly executing the processing from the time t20 to the time t90 while reversing the scanning direction of the carriage 21. In other words, the liquid ejecting apparatus 1 forms a desired image on the medium P by repeatedly executing the printing process mode and the reversal processing standby mode after the printing process standby mode.

In the liquid ejecting apparatus 1 according to the embodiment that operates as described above, the temperature information output section 503 included in the control circuit 500 of the temperature information output circuit 26 acquires the held temperature information group Gtc which is the head temperature signal TC corresponding to the temperature of the print head 22 and includes the m pieces of held temperature information dtr held in the shift register 540 in at least one of detection periods Tdet1 to Tdet6 illustrated in FIG. 16. Then, the temperature information output section 503 generates the temperature information signal TI based on the acquired held temperature information group Gtc.

The detection period Tdet1 is a period during the printing process standby mode. The detection period Tdet1 starts when a predetermined period Δt elapses after the drive circuit 50 changes from a state of outputting the drive signal COM in which the voltage value changes to a state of outputting the drive signal COM in which the voltage value is constant at the voltage Vb at the time t10. The detection period Tdet1 ends immediately before the drive circuit 50 starts outputting the drive signal COM including the minute vibration waveform obs. In the detection period Tdet1, the drive circuit 50 outputs the drive signal COM in which the voltage value is constant at the voltage Vb, and the selection circuits 230 are controlled to be non-conductive.

The detection period Tdet2 is a period during the printing process standby mode. The detection period Tdet2 starts when a predetermined period Δt elapses after the drive circuit 50 changes from a state of outputting the drive signal COM including the minute vibration waveform obs to a state of outputting the drive signal COM in which the voltage value is constant at the voltage Vb. The detection period Tdet2 ends at the time t20 when the image information signal is input from the external apparatus. In the detection period Tdet2, the drive circuit 50 outputs the drive signal COM in which the voltage value is constant at the voltage Vb, and the selection circuits 230 are controlled to be non-conductive.

The detection period Tdet3 is a period during the print processing mode. The detection period Tdet3 starts when a predetermined period Δt elapses after the drive circuit 50 changes from a state of outputting the drive signal COM in which the voltage value changes to a state of outputting the drive signal COM in which the voltage value is constant at the voltage Vc at the time t20. The detection period Tdet3 ends at the time t40 when the drive circuit 50 starts outputting the drive signal COM in which the trapezoidal waveforms Adp, Bdp, and Cdp are continuous. In the detection period Tdet3, the drive circuit 50 outputs the drive signal COM in which the voltage value is constant at the voltage Vc, and the selection circuits 230 are controlled to be non-conductive.

The detection period Tdet4 is a period during the print processing mode. The detection period Tdet4 starts when a predetermined period Δt elapses after the drive circuit 50 changes from a state of outputting the drive signal COM in which the trapezoidal waveforms Adp, Bdp, and Cdp are continuous to a state of outputting the drive signal COM in which the voltage value is constant at the voltage Vc at the time t70. The detection period Tdet4 ends at the time t90 immediately before the voltage value of the drive signal COM output by the drive circuit 50 changes toward the voltage Vb. In the detection period Tdet4, the drive circuit 50 outputs the drive signal COM in which the voltage value is constant at the voltage Vc, and the selection circuits 230 are controlled to be non-conductive.

The detection period Tdet5 is a period during the reversal processing standby mode. The detection period Tdet5 starts when a predetermined period Δt elapses after the drive circuit 50 changes from a state of outputting the drive signal COM in which the voltage value changes to a state of outputting the drive signal COM in which the voltage value is constant at the voltage Vb at the time t90. The detection period Tdet5 ends immediately before the drive circuit 50 starts outputting the drive signal COM including the minute vibration waveform obs. In the detection period Tdet5, the drive circuit 50 outputs the drive signal COM in which the voltage value is constant at the voltage Vb, and the selection circuits 230 are controlled to be non-conductive.

The detection period Tdet6 is a period during the reversal processing standby mode. The detection period Tdet6 starts when a predetermined period Δt elapses after the drive circuit 50 changes from a state of outputting the drive signal COM including the minute vibration waveform obs to a state of outputting the drive signal COM in which the voltage value is constant at the voltage Vb. The detection period Tdet6 ends at the time t100 at which the reversal processing is completed. In the detection period Tdet6, the drive circuit 50 outputs the drive signal COM in which the voltage value is constant at the voltage Vb, and the selection circuits 230 are controlled to be non-conductive.

That is, the temperature information output circuit 26 acquires the head temperature signal TC corresponding to the temperature of the print head 22 acquired in at least one of a period in which the drive circuit 50 outputs the drive signal COM in which the voltage value is constant and a period in which the selection circuits 230 are controlled to be non-conductive. The one of the periods is a period in which the drive signal VOUT in which the voltage value changes is not supplied to each of the piezoelectric elements 60, that is, a period in which all of the piezoelectric elements 60 included in the print head 22 are not driven. In the period, the temperature information output circuit 26 generates, based on the held temperature information group Gtc including the m pieces of held temperature information dtr held in the shift register 540, the temperature information signal TI corresponding to the temperature of the corresponding print head 22 and outputs the temperature information signal TI to the control circuit 100. In other words, the temperature information output circuit 26 acquires the head temperature signal TC corresponding to the temperature of the print head 22 acquired in the period in which the drive signal VOUT in which the voltage value changes is not supplied to the piezoelectric elements 60, the piezoelectric elements 60 are not driven by the drive signal VOUT, and thus the vibration plate 350 is not deformed, and the temperature information output circuit 26 outputs the temperature information signal TI corresponding to the acquired head temperature signal TC.

This reduces the possibility that noise or the like caused by the propagation of the drive signal VOUT, the deformation of the vibration plate 350, and an instantaneous change in the temperature of the ink stored in the pressure chambers 312 may be superimposed on the head temperature signal TC acquired by the temperature information output circuit 26, and improves the accuracy of the head temperature signal TC acquired by the temperature information output circuit 26, that is, the accuracy of detecting the temperatures of the pressure chambers 312 to be detected. As a result, the reliability of the temperature information signal TI output by the temperature information output circuit 26 is improved.

The temperature information output circuit 26 may acquire the head temperature signal TC corresponding to the temperature of the print head 22 acquired in the period in which the drive signal VOUT in which the voltage value changes is not supplied to the piezoelectric elements 60, the piezoelectric elements 60 are not driven by the drive signal VOUT, and thus the vibration plate 350 is not deformed, and may output the temperature information signal TI corresponding to the acquired head temperature signal TC. Therefore, the head temperature signal TC to be used to generate the temperature information signal TI by the temperature information output circuit 26 may be acquired in the period in which the drive signal VOUT in which the voltage value changes is not supplied to the piezoelectric elements 60 and the vibration plate 350 is not deformed, and may not be acquired in the detection periods Tdet1 to Tdet6 described above. Therefore, in the following description, the detection periods Tdet1 to Tdet6 in which the temperature information output circuit 26 preferably acquires the head temperature signal TC to be used to generate the temperature information signal TI may be collectively referred to as a detection period Tdet.

From the viewpoint of improving the accuracy of detecting the temperature of the print head 22 based on the temperature information signal TI, it is preferable that the temperature information output circuit 26 generate the temperature information signal TI based on a larger number of pieces of held temperature information dtr acquired in the detection period Tdet. Therefore, ideally, it is preferable that the temperature information output circuit 26 acquire the m pieces of held temperature information dtr in the detection period Tdet and generate the temperature information signal TI based on all of the m pieces of held temperature information dtr acquired in the detection period Tdet.

However, the detection period Tdet varies depending on the product specifications of the liquid ejecting apparatus 1, and also varies depending on variations in the circuits and components constituting the liquid ejecting apparatus 1. In addition, the time required for the shift register 540 of the temperature information output circuit 26 to hold the m pieces of digital temperature information dtc as the m pieces of held temperature information dtr also varies due to a variation in the clock signal CK1 or the like. Therefore, in order to implement a configuration in which the temperature information output circuit 26 acquires all of the m pieces of held temperature information dtr which can be held in the shift register 540 in the detection period Tdet and generates the temperature information signal TI based on all of the m pieces of held temperature information dtr acquired in the detection period Tdet, it is necessary to provide a sufficiently long detection period Tdet in which a difference and various variations in specifications of the liquid ejecting apparatus 1 are taken into consideration.

However, if the detection period Tdet is lengthened, the time required for the liquid ejecting apparatus 1 to form a desired image on the medium P is lengthened, and the productivity of printed matter in the liquid ejecting apparatus 1 may decrease. Therefore, as in the liquid ejecting apparatus 1 and the head unit 20 according to the embodiment, when each of the temperature detection circuits 250 includes the resistance wiring 401 formed on the vibration plate 350 and outputs the head temperature signal TC corresponding to the temperature of each of the print heads 22, that is, the temperature of the ink stored in the pressure chambers 312 of each of the print heads 22 based on a change in the resistance value of the resistance wiring 401, the temperature information output circuit 26 acquires and holds the head temperature signal TC at a predetermined period and outputs the temperature information signal TI corresponding to the temperature of each of the print heads 22 using the pieces of held temperature information dtr corresponding to the plurality of pieces of held head temperature signals TC, the number of samples of the pieces of held temperature information dtr to be used to calculate the temperature of each of the print heads 22 is required to be individually defined for each of the liquid ejecting apparatus 1 and the head unit 20, and preferably for each of the print heads 22 included in the liquid ejecting apparatus 1, based on the detection period Tdet determined based on the specifications of the liquid ejecting apparatus 1 and the head unit 20 from the viewpoint of improving the accuracy of detecting the temperatures of the print heads 22 based on the output temperature information signal TI.

The number of samples of the pieces of held temperature information dtr to be used to calculate the temperature of each of the print heads 22 may be individually measured and stored, for example, at the stage of manufacturing the liquid ejecting apparatus 1 or when the print heads 22 and the head unit 20 including the print heads 22 are replaced. However, in this case, there is a concern that the number of work processes required for manufacturing the liquid ejecting apparatus 1 may increases and that the productivity of the liquid ejecting apparatus 1 may decrease. In addition, manpower and equipment for individually measuring and storing the number of samples of the pieces of held temperature information dtr to be used to calculate the temperature of each of the print heads 22 to be stored are required, and there is a concern that the cost of the liquid ejecting apparatus 1 may increase.

The liquid ejecting apparatus 1 according to the embodiment has a characteristic configuration in which the optimum number of samples of the pieces of held temperature information dtr to be used to calculate the temperature of each of the print heads 22 can be easily determined in each detection period Tdet determined based on the specifications of the liquid ejecting apparatus 1 and the head unit 20. Accordingly, it is possible to reduce the possibility of an increase in the number of work processes and to determine the optimum number of samples of the pieces of held temperature information dtr to be used to calculate the temperature of each of the print heads 22 in each detection period Tdet determined based on the specifications of the liquid ejecting apparatus 1 and the head unit 20 without newly investing in manpower and equipment, and thus it is possible to increase the accuracy of detecting the temperatures.

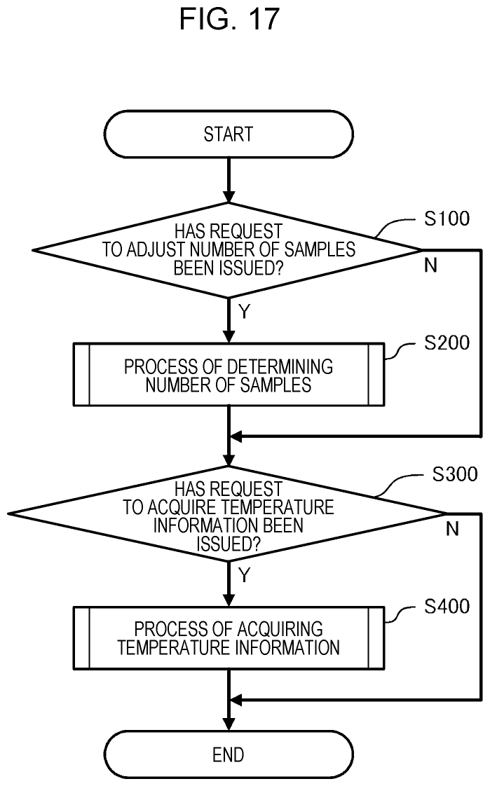

In the liquid ejecting apparatus 1 according to the present embodiment, a method of determining the optimum number of samples of the pieces of held temperature information dtr to be used to calculate the temperature of each of the print heads 22 in each detection period Tdet and a method of acquiring the temperature of each of the print heads 22 based on the determined number of samples will be described. FIG. 17 is a diagram illustrating an example of a method of determining the optimum number of samples of the pieces of held temperature information dtr and a method of acquiring the temperatures of the print heads 22 based on the number of samples. As illustrated in FIG. 17, the control circuit 100 determines whether or not a request to adjust the number of samples has been issued (step S100). The request to adjust the number of samples is issued by a user's operation when the user of the liquid ejecting apparatus 1 or a producer of the liquid ejecting apparatus 1 adjusts and determines the optimum number of samples of the pieces of held temperature information dtr to be used to calculate the temperature of the print head 22. The request to adjust the number of samples may be issued by an operation of the liquid ejecting apparatus 1 by the user or may be automatically issued at the stage of manufacturing the liquid ejecting apparatus 1, when the print head 22 is replaced, or when a power supply voltage is first supplied.

When the control circuit 100 determines that the request to adjust the number of samples has been issued (Y in step S100), the control circuit 100 executes a process of adjusting and determining the optimum number of samples of the pieces of held temperature information dtr to be used to calculate the temperature of the print head 22 (step S200). In addition, when the control circuit 100 determines that the request to adjust the number of samples has not been issued (N in step S100), or after the process of determining the number of samples in step S200 is ended, the control circuit 100 determines whether or not a request to acquire temperature information indicating the temperature of the print head 22 has been issued (step S300). The request to acquire the temperature information may be issued in response to a request from the user of the liquid ejecting apparatus 1, or may be issued based on the number of printing surfaces of the medium P on which the liquid ejecting apparatus 1 forms an image, the time when the liquid ejecting apparatus 1 is used, or the like in a period in which the liquid ejecting apparatus 1 ejects liquid onto the medium P. In addition, the request to acquire the temperature information may be issued when the liquid ejecting apparatus 1 starts forming an image on the medium P, and may be continuously issued during a period in which the liquid ejecting apparatus 1 forms an image on the medium P.

When the control circuit 100 determines that the request to acquire the temperature information has been issued (Y in step S300), the control circuit 100 executes a process of acquiring temperature information indicating the temperature of the print head 22 (step S400). In accordance with the temperature of the print head 22 acquired by the process of acquiring the temperature information, various signals for controlling the operation of the print head 22 are corrected and adjusted.

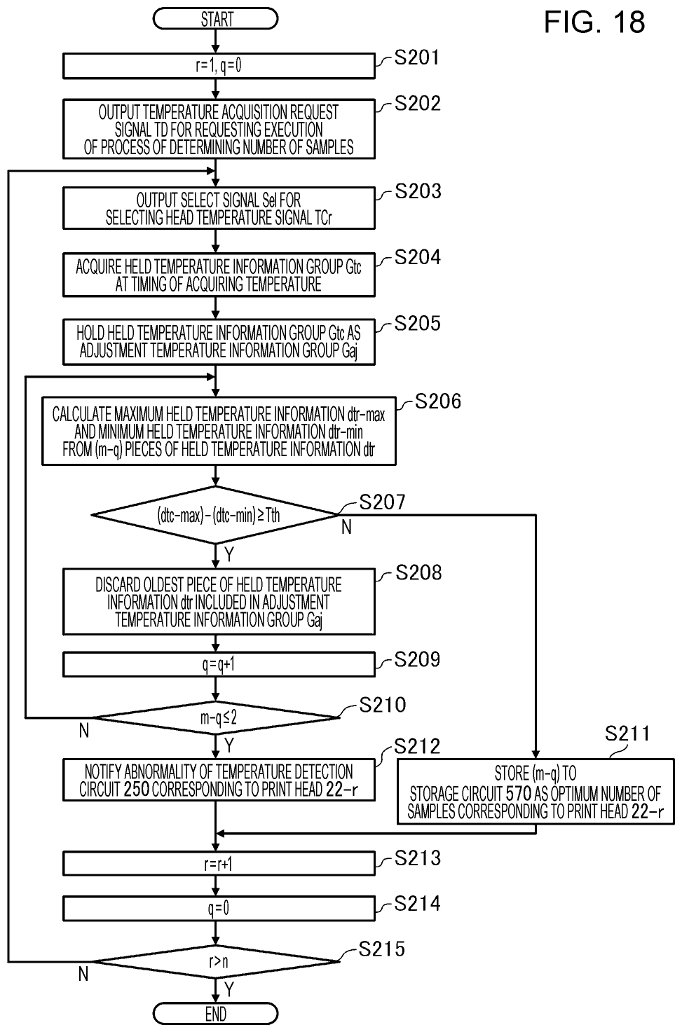

Next, an example of the process of determining the number of samples will be described. FIG. 18 is a diagram illustrating an example of the process of determining the number of samples. As illustrated in FIG. 18, when the process of determining the number of samples is started, “1” is assigned to a variable r and “0” is assigned to a variable q as an initial setting (step S201). Thereafter, the control circuit 100 generates a temperature acquisition request signal TD including information for requesting the execution of the process of determining the number of samples, and outputs the temperature acquisition request signal TD to the temperature information output circuit 26 (step S202).

When the temperature acquisition request signal TD including the information for requesting the execution of the process of determining the number of samples is input to the temperature information output circuit 26, the control circuit 500 outputs, to the multiplexer 510, a select signal Sel for selecting the head temperature signal TCr output by the print head 22-r, that is, a select signal Sel for selecting the head temperature signal TC1 output by the print head 22-1 since the variable r=1 (step S203). Accordingly, the shift register 540 acquires the head temperature signal TC1 output by the print head 22-1 at periods of the clock signal CK1 and holds the head temperature signal TC1 as pieces of held temperature information dtr. That is, the shift register 540 holds the m pieces of held temperature information dtr obtained by acquiring the voltage value of the head temperature signal TC1 output by the print head 22-1 at the periods of the clock signal CK1.

Thereafter, at a predetermined acquisition timing that is included in the detection period Tdet and at which the temperature of the print head 22-1 is acquired, the control circuit 500 generates a read request signal Ltc for reading the m pieces of held temperature information dtr held in the shift register 540, and outputs the read request signal Ltc to the shift register 540. That is, the control circuit 500 acquires the held temperature information group Gtc including the m pieces of held temperature information dtr held in the shift register 540 at the acquisition timing (step S204). Then, the control circuit 500 generates a temperature information signal TI including the acquired held temperature information group Gtc, that is, the control circuit 500 generates a temperature information signal TI including the m pieces of held temperature information dtr, and outputs the temperature information signal TI to the control circuit 100.

The control circuit 100 acquires the held temperature information group Gtc included in the input temperature information signal TI and holds the held temperature information group Gtc as an adjustment temperature information group Gaj (step S205). In this case, the adjustment temperature information group Gaj held in the control circuit 100 includes (m-q) pieces of held temperature information dtr, that is, the m pieces of held temperature information dtr since the variable q=0. Then, the control circuit 100 calculates, as maximum held temperature information dtr-max, the maximum value of the (m-q) pieces of held temperature information dtr, that is, the maximum value of the m pieces of held temperature information dtr, and calculates, as minimum held temperature information dtr-min, the minimum value of the (m-q) pieces of held temperature information dtr, that is, the minimum value of the m pieces of held temperature information dtr. That is, the control circuit 100 calculates the maximum held temperature information dtr-max and the minimum held temperature information dtr-min from the (m-q) pieces of held temperature information dtr, that is, the m pieces of held temperature information dtr since the variable q=0 (step S206).

In this case, the maximum value of the (m-q) pieces of held temperature information dtr included in the adjustment temperature information group Gaj may be, for example, the maximum value of the temperature defined by the (m-q) pieces of held temperature information dtr or the maximum value of the temperature defined by (m-q) pieces of digital temperature information dtc corresponding to the (m-q) pieces of held temperature information dtr, or the maximum value of the (m-q) pieces of held temperature information dtr included in the adjustment temperature information group Gaj may be the maximum value of the voltage values of the (m-q) pieces of held temperature information dtr or the maximum value of the voltage values of the (m-q) pieces of digital temperature information dtc corresponding to the (m-q) pieces of held temperature information dtr. Similarly, the minimum value of the (m-q) pieces of held temperature information dtr included in the adjustment temperature information group Gaj may be, for example, the minimum value of the temperature defined by the (m-q) pieces of held temperature information dtr or the minimum value of the temperature defined by (m-q) pieces of digital temperature information dtc corresponding to the (m-q) pieces of held temperature information dtr, or the minimum value of the (m-q) pieces of held temperature information dtr included in the adjustment temperature information group Gaj may be the minimum value of the voltage values of the (m-q) pieces of held temperature information dtr or the minimum value of the voltage values of the (m-q) pieces of digital temperature information dtc corresponding to the (m-q) pieces of held temperature information dtr.

Then, the control circuit 100 determines whether or not a difference between the calculated maximum held temperature information dtr-max and the calculated minimum held temperature information dtr-min is greater than or equal to predetermined threshold information Tth (step S207). When the control circuit 100 determines that the difference between the maximum held temperature information dtr-max and the minimum held temperature information dtr-min is greater than or equal to the predetermined threshold information Tth (Y in step S207), the control circuit 100 discards a piece of held temperature information dtr corresponding to the oldest piece of digital temperature information dtc among the m pieces of held temperature information dtr included in the adjustment temperature information group Gaj (step S208). That is, the number of pieces of held temperature information dtr included in the adjustment temperature information group Gaj decreases by one.

In the liquid ejecting apparatus 1 according to the present embodiment, the piece of held temperature information dtr corresponding to the oldest piece of digital temperature information dtc among the m pieces of held temperature information dtr included in the adjustment temperature information group Gaj is the piece of held temperature information dtrm corresponding to the piece of digital temperature information dtc held in the register Rgm among the registers Rg1 to Rgm included in the shift register 540. That is, when the control circuit 100 determines that the difference between the maximum held temperature information dtr-max and the minimum held temperature information dtr-min is greater than or equal to the predetermined threshold information Tth (Y in step S207), the control circuit 100 discards a piece of held temperature information dtr(m-q) corresponding to the piece of digital temperature information dtc held in the register Rg(m-q) among the (m-q) pieces of held temperature information dtr included in the adjustment temperature information group Gaj (step S208). In this case, a case where “the piece of held temperature information dtr(m-q) is discarded” is not limited to a case where information corresponding to the piece of held temperature information dtr(m-q) is deleted from the adjustment temperature information group Gaj, but includes a case where the adjustment temperature information group Gaj holds the information corresponding to the piece of held temperature information dtr(m-q) and the piece of held temperature information dtr(m-q) is not used in the subsequent processing.

When the control circuit 100 discards the piece of held temperature information dtr corresponding to the oldest piece of digital temperature information dtc among the m pieces of held temperature information dtr included in the adjustment temperature information group Gaj, the number of pieces of held temperature information dtr included in the adjustment temperature information group Gaj decreases by one. Therefore, the control circuit 100 adds 1 to the variable q (step S209). After discarding the oldest piece of digital temperature information dtc, the control circuit 100 determines whether or not the number of pieces of held temperature information dtr included in the adjustment temperature information group Gaj is not less than or equal to two. That is, the control circuit 100 determines whether or not (m-q)≤2 is satisfied (step S210). When the control circuit 100 determines that the number of pieces of held temperature information dtr included in the adjustment temperature information group Gaj is not less than or equal to two, that is, when (m-q)≤2 is not satisfied (N in step S210), the processing in steps S205 to S209 described above is executed again.

That is, until the difference between the maximum held temperature information dtr-max and the minimum held temperature information dtr-min of the plurality of pieces of held temperature information dtr included in the adjustment temperature information group Gaj becomes less than the predetermined threshold information Tth (N in step S207) or until the number of pieces of held temperature information dtr included in the adjustment temperature information group Gaj becomes less than or equal to two (Y in step S210), a piece of held temperature information dtr is discarded from the plurality of pieces of held temperature information dtr included in the adjustment temperature information group Gaj in the order in which the pieces of held temperature information dtr were acquired.

When the control circuit 100 determines that the difference between the maximum held temperature information dtr-max and the minimum held temperature information dtr-min of the plurality of pieces of held temperature information dtr included in the adjustment temperature information group Gaj is less than the predetermined threshold information Tth (N in step S207), the control circuit 100 determines that (m-q) which is the number of pieces of held temperature information dtr included in the adjustment temperature information group Gaj at this time is the optimum number of samples of the pieces of held temperature information dtr to be used to calculate the temperature of the print head 22-1. Then, the control circuit 100 generates a temperature acquisition request signal TD including information indicating that (m-q) is the optimum number of samples of the pieces of held temperature information dtr to be used to calculate the temperature of the print head 22-1, and outputs the temperature acquisition request signal TD to the temperature information output circuit 26. The control circuit 500 included in the temperature information output circuit 26 stores (m-q) to the storage circuit 570 as the optimum number of samples of the pieces of held temperature information dtr to be used to calculate the temperature of the print head 22-1, based on the input temperature acquisition request signal TD. That is, the control circuit 500 stores (m-q) to the storage circuit 570 as the optimum number of samples for the print head 22-1 (step S211).

On the other hand, when the control circuit 100 determines that the number of pieces of held temperature information dtr included in the adjustment temperature information group Gaj is less than or equal to two (Y in step S210), the control circuit 100 determines that the temperature detection circuit 250 of the print head 22-1 has not normally acquired the temperature of the print head 22-1, and notifies the user of the abnormality of the temperature detection circuit 250 of the print head 22-1 via the notification circuit 94. That is, the control circuit 100 notifies the abnormality of the temperature detection circuit 250 corresponding to the print head 22-1 (step S212).

After the control circuit 500 stores (m-q) to the storage circuit 570 as the optimum number of samples for the print head 22-1 in step S211, or after the control circuit 100 notifies the abnormality of the temperature detection circuit 250 corresponding to the print head 22-1 in step S212, the control circuit 100 adds 1 to the variable r (step S213), initializes the variable q to 0 (step S214), and determines whether or not the variable r is greater than n which is the total number of print heads 22 included in the liquid ejecting apparatus 1 (step S215). When the control circuit 100 determines that the variable r is not greater than n (N in step S215), that is, when the control circuit 100 determines that the variable r is less than or equal to n which is the total number of print heads 22 included in the liquid ejecting apparatus 1, the processing in steps S203 to S214 described above is executed again. Accordingly, the optimum number of samples of the pieces of held temperature information dtr to be used to calculate the temperature corresponding to each of the print heads 22-1 to 22-n included in the liquid ejecting apparatus 1 is calculated for each of the print heads 22-1 to 22-n included in the liquid ejecting apparatus 1, and is stored in the storage circuit 570.

On the other hand, when the control circuit 100 determines that the variable r is greater than n (Y in step S215), that is, when the variable r exceeds n which is the total number of the print heads 22 included in the liquid ejecting apparatus 1, the control circuit 100 determines that the calculation of the optimum number of samples of the pieces of held temperature information dtr to be used to calculate the temperature corresponding to each of the print heads 22-1 to 22-n included in the liquid ejecting apparatus 1 has been completed, and the process of determining the number of samples ends.

As described above, in the liquid ejecting apparatus 1 according to the present embodiment, in the process of determining the number of samples, the temperature information output circuit 26 holds m pieces of digital temperature information dtc which are a plurality of pieces of digital temperature information dtc acquired at predetermined sampling periods defined by the clock signal CK1, and the control circuit 100 acquires, as the adjustment temperature information group Gaj, the m pieces of digital temperature information dtc which are the plurality of pieces of digital temperature information dtc held in the temperature information output circuit 26. Then, the control circuit 100 determines the number of samples of the pieces of digital temperature information dtc to be used to generate the temperature information signal TI based on the acquired adjustment temperature information group Gaj. Thereafter, the number of samples of the pieces of digital temperature information dtc determined by the control circuit 100 is stored in the storage circuit 570 included in the temperature information output circuit 26.

Specifically, in the determination of the number of samples of the pieces of digital temperature information dtc, the control circuit 100 determines the optimum number of samples of the pieces of held temperature information dtr to be used to generate the temperature information signal TI and to calculate the temperature corresponding to each of the print heads 22-1 to 22-n included in the liquid ejecting apparatus 1 based on the difference between the maximum value and the minimum value of the temperature of the pressure chamber 312 corresponding to each of the plurality of pieces of digital temperature information dtc included in the adjustment temperature information group Gaj.

In detail, the control circuit 100 compares the difference between the maximum value and the minimum value of the temperature of the pressure chamber 312 corresponding to each of the plurality of pieces of digital temperature information dtc included in the adjustment temperature information group Gaj with the threshold information Tth which is a predetermined threshold. When the difference between the maximum value and the minimum value of the temperature of the pressure chamber 312 corresponding to each of the plurality of pieces of digital temperature information dtc included in the adjustment temperature information group Gaj is less than the threshold information Tth, the control circuit 100 determines the number of the plurality of pieces of digital temperature information dtc included in the adjustment temperature information group Gaj as the optimum number of samples of the pieces of held temperature information dtr to be used to generate the temperature information signal TI and stores the determined number to the storage circuit 570. When the difference between the maximum value and the minimum value of the temperature of the pressure chamber 312 corresponding to each of the plurality of pieces of digital temperature information dtc included in the adjustment temperature information group Gaj is greater than or equal to the threshold information Tth. the control circuit 100 discards a piece of digital temperature information dtc acquired earliest among the plurality of pieces of digital temperature information dtc included in the adjustment temperature information group Gaj from the adjustment temperature information group Gaj, and compares the difference between the maximum value and the minimum value of the temperature of the pressure chamber 312 corresponding to each of the plurality of pieces of digital temperature information dtc included in the adjustment temperature information group Gaj after the discarding with the threshold information Tth which is a predetermined threshold again.

Then, the control circuit 100 repeatedly executes the comparison until the difference between the maximum value and the minimum value of the temperature of the pressure chamber 312 corresponding to each of the plurality of pieces of digital temperature information dtc included in the adjustment temperature information group Gaj becomes less than the threshold information Tth, and determines the optimum number of samples of the pieces of held temperature information dtr to be used to generate the temperature information signal TI. On the other hand, when the difference between the maximum value and the minimum value of the temperature of the pressure chamber 312 corresponding to each of the plurality of pieces of digital temperature information dtc included in the adjustment temperature information group Gaj is greater than or equal to the threshold information Tth, the control circuit 100 repeatedly discards, from the adjustment temperature information group Gaj, a piece of digital temperature information dtc acquired earliest. When the number of pieces of digital temperature information dtc included in the adjustment temperature information group Gaj after the discarding becomes less than or equal to two, the control circuit 100 determines that the temperature of the corresponding print head 22 is not normally acquired, and notifies abnormality information indicating the temperature detection circuit 250 included in the corresponding print head 22.

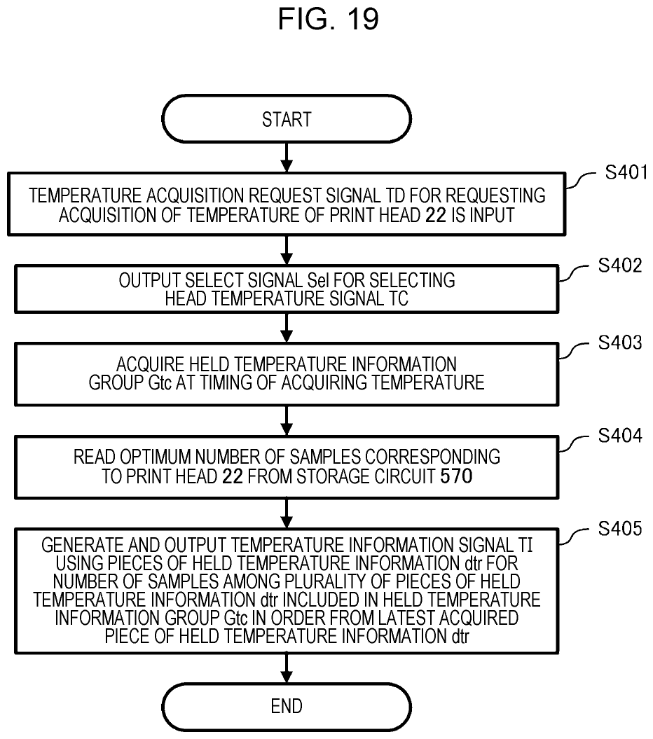

Next, an example of the process of acquiring temperature information will be described. FIG. 19 is a diagram illustrating an example of the process of acquiring temperature information. The process of acquiring temperature information is executed on each of the print heads 22-1 to 22-n. The same process is executed on each of the print heads 22-1 to 22-n. Therefore, in the following description, a case where the process of acquiring temperature information is executed on a print head 22 among the print heads 22-1 to 22-n will be described as an example. As illustrated in FIG. 19, the process of acquiring temperature information is started when the control circuit 100 generates a temperature acquisition request signal TD for requesting the execution of the process of acquiring temperature information of the print head 22 and outputs the temperature acquisition request signal TD to the temperature information output circuit 26.

When the temperature acquisition request signal TD including the information for requesting the execution of the process of acquiring temperature information is input to the temperature information output circuit 26 (step S401), the control circuit 500 outputs, to the multiplexer 510, a select signal Sel for selecting a head temperature signal TC output by the print head 22 (step S402). Accordingly, the shift register 540 acquires the head temperature signal TC output by the print head 22 at periods of the clock signal CK1 and holds the head temperature signal SL as pieces of held temperature information dtr. That is, the shift register 540 holds the m pieces of held temperature information dtr obtained by acquiring the voltage value of the head temperature signal TC output by the print head 22 at the periods of the clock signal CK1.

Thereafter, at a predetermined acquisition timing that is included in the detection period Tdet and at which the temperature of the print head 22 is acquired, and is the same timing as that in the above-described step S204, the control circuit 500 generates a read request signal Ltc for reading the m pieces of held temperature information dtr held in the shift register 540, and outputs the read request signal Ltc to the shift register 540. That is, the control circuit 500 acquires the held temperature information group Gtc including the m pieces of held temperature information dtr held in the shift register 540 at the acquisition timing (step S403).

Further, the control circuit 500 reads the optimum number of samples for the print head 22 from the storage circuit 570 (step S404). Then, the control circuit 500 generates and outputs a temperature information signal TI by using the pieces of held temperature information dtr corresponding to the number of samples in order from the latest acquired piece of held temperature information dtr among the m pieces of held temperature information dtr included in the acquired held temperature information group Gtc (step S405).

Specifically, when the optimum number of samples for the print head 22 read from the storage circuit 570 by the control circuit 500 is (m-q), the control circuit 500 generates and outputs the temperature information signal TI using the pieces of held temperature information dtr1 to dtr(m-q) corresponding to the (m-q) pieces of digital temperature information dtc held in the registers Rg1 to Rg(m-q) among the m pieces of held temperature information dtr included in the acquired held temperature information group Gtc.

That is, in the process of acquiring temperature information, the temperature information output circuit 26 acquires the m pieces of held temperature information dtr held in the shift register 540 by outputting the read request signal Ltc to the shift register 540 at a predetermined acquisition timing that is the timing of outputting the temperature information signal T1 and is included in the detection period Tdet and at which the temperature of the print head 22 is acquired, and the temperature information output circuit 26 selects the same number of pieces of digital temperature information dtc as the calculated number of samples in the order in which a timing at which a piece of digital temperature information dtc is acquired is closest to the predetermined acquisition timing that is the timing of outputting the read request signal Ltc to the shift registers 540 and is included in the detection period Tdet and at which the temperature of the print head 22 is acquired, and generates the temperature information signal TI using the selected piece of digital temperature information dtc. Then, the temperature information output circuit 26 outputs the generated temperature information signal TI.

The control circuit 500 may generate the temperature information signal TI including the maximum and minimum values of temperatures defined by the pieces of held temperature information dtr1 to dtr(m-q) and output the generated temperature information signal TI to the control circuit 100, or may generate the temperature information signal TI corresponding to the mean value of the temperatures defined by the pieces of held temperature information dtr1 to dtr(m-q) and output the generated temperature information signal TI to the control circuit 100. Further, the control circuit 100 may generate the temperature information signal TI having a value obtained by substituting the pieces of held temperature information dtr1 to dtr(m-q) into a predetermined conversion formula or table, and output the generated temperature information signal TI to the control circuit 100.

The control circuit 100 is an example of a processor, each of the electrodes 360 is an example of a first electrode, the electrode 380 is an example of a second electrode, the direction along the Z axis in the print head 22 is an example of a stacking direction, the +Z side in the print head 22 is an example of one side, the −Z side in the print head 22 is an example of the other side, and the resistance wiring 401 is an example of a temperature detecting section. In addition, the pieces of digital temperature information dtc and the pieces of held temperature information dtr corresponding to the pieces of digital temperature information dtc are examples of pieces of temperature information, and the threshold information Tth is an example of a predetermined threshold. In addition, steps S206 to S212 included in the process of determining the number of samples are an example of a temperature comparison process. The timing at which the control circuit 500 outputs the read request signal Ltc for reading the m pieces of held temperature information dtr held in the shift register 540 is an example of an output timing.

### 8. Operational Effects

In the liquid ejecting apparatus 1 and the head unit 20 according to the present embodiment which are configured as described above, the print head 22 includes the piezoelectric element 60 that includes the electrode 360, the electrode 380, and the piezoelectric body 370 located between the electrode 360 and the electrode 380 in the direction along the Z axis in which the electrode 360, the electrode 380, and the piezoelectric body 370 are stacked, and that receives the drive signal COM and is driven in response to the drive signal COM, the vibration plate 350 that is located on the +Z side, which is one side of the piezoelectric element 60 in the direction along the Z axis, and is deformed by the driving of the piezoelectric element 60, the pressure chamber substrate 310 that is located on the +Z side, which is one side of the vibration plate 350 in the direction along the Z axis, and is provided with the pressure chamber 312 in which ink is stored and that changes in volume due to the deformation of the vibration plate 350, the nozzle 321 from which the ink is ejected in accordance with the change in the volume of the pressure chamber 312, and the resistance wiring 401 that is located on the −Z side, which is the other side of the vibration plate 350 in the direction along the Z axis, and acquires a temperature corresponding to the temperature of the pressure chamber 312. Therefore, the resistance wiring 401 that acquires a temperature corresponding to the temperature of the pressure chamber 312 can be disposed in the vicinity of the pressure chamber 312, and as a result, the accuracy of detecting the temperature of the ink stored in the pressure chamber 312 is improved.

When the accuracy of detecting the temperature of the print head 22 is improved by using the print head 22 having the above-described configuration, it is preferable that the temperature information output circuit 26 acquire a larger number of pieces of digital temperature information dtc. On the other hand, if the number of pieces of digital temperature information dtc to be used to calculate the temperature of the print head 22 is carelessly increased, noise or the like caused by the propagation of the drive signal VOUT, the deformation of the vibration plate 350, and an instantaneous change in the temperature of the ink stored in the pressure chamber 312 may be superimposed on the acquired pieces of digital temperature information dtc, and as a result, the accuracy of detecting the temperature of the print head 22 may decrease. That is, it is possible to further improve the accuracy of detecting the temperature of the print head 22 by appropriately setting the number of samples of the pieces of digital temperature information dtc to be used to calculate the temperature of the print head 22.

In the liquid ejecting apparatus 1 and the head unit 20 according to the present embodiment, the control circuit 100 acquires all of pieces of digital temperature information dtc which can be held in the temperature information output circuit 26, and determines the optimum number of samples of pieces of held temperature information dtr which can be used to generate the temperature information signal TI based on all of the plurality of pieces of acquired digital temperature information dtc. As a result, the optimum number of samples of the pieces of held temperature information dtr to be used to generate the temperature information signal TI can be determined to be an optimum value without the need for new manpower and equipment. That is, in the liquid ejecting apparatus 1 and the head unit 20 according to the present embodiment, it is possible to improve the accuracy of detecting the temperature of the print head 22 with a simple configuration without requiring new equipment or manpower.

In this case, when the difference between the maximum value and the minimum value of the temperature of the pressure chamber 312 corresponding to each of the plurality of pieces of digital temperature information dtc included in the adjustment temperature information group Gaj is less than the threshold information Tth, the control circuit 100 determines the number of the pieces of digital temperature information dtc included in the adjustment temperature information group Gaj as the optimum number of samples of the pieces of held temperature information dtr to be used to generate the temperature information signal TI. When the difference between the maximum value and the minimum value of the temperature of the pressure chamber 312 corresponding to each of the plurality of pieces of digital temperature information dtc included in the adjustment temperature information group Gaj is greater than or equal to the threshold information Tth, the control circuit 100 discards a piece of digital temperature information dtc acquired earliest among the plurality of pieces of digital temperature information dtc included in the adjustment temperature information group Gaj, and compares again the difference between the maximum value and the minimum value of the temperature of the pressure chamber 312 corresponding to each of the plurality of pieces of digital temperature information dtc included in the adjustment temperature information group Gaj with the threshold information Tth that is the predetermined threshold. Accordingly, it is possible to remove an old sample on which noise or the like caused by the propagation of the drive signal VOUT, the deformation of the vibration plate 350, and an instantaneous change in the temperature of the ink stored in the pressure chamber 312 is highly likely to be superimposed, and it is possible to more appropriately determine the optimum number of samples of the pieces of held temperature information dtr to be used to generate the temperature information signal TI.

Then, the temperature information output circuit 26 selects the same number of pieces of digital temperature information dtc as the calculated number of samples in the order in which a timing at which a piece of digital temperature information dtc is acquired is closest to the predetermined acquisition timing that is included in the detection period Tdet and at which the temperature of the print head 22 is acquired, and generates the temperature information signal TI using the selected piece of digital temperature information dtc, thereby reducing noise or the like caused by the propagation of the drive signal VOUT, the deformation of the vibration plate 350, and an instantaneous change in the temperature of the ink stored in the pressure chamber 312, and improving the accuracy of detecting the temperature of the print head 22.

Although the embodiments and modifications have been described above, the present invention is not limited to these embodiments, and can be implemented in various modes without departing from the scope of the present disclosure. For example, the above-described embodiments may be appropriately combined.

The present disclosure includes substantially the same configurations (for example, a configuration having the same functions, methods, and results, or a configuration having the same purposes and effects) as the configurations described in the embodiments. Further, the present disclosure includes configurations in which non-essential sections of the configuration described in the embodiments are replaced. In addition, the present disclosure includes configurations that obtain the same operational effects or configurations that can achieve the same purposes as those of the configurations described in the embodiments. Further, the present disclosure includes configurations in which a known technology is added to the configurations described in the embodiments.

The following contents are derived from the above-described embodiments.

In an aspect, a liquid ejecting apparatus includes a drive circuit that outputs a drive signal, a print head that receives the drive signal and ejects liquid in response to the drive signal, a temperature information output circuit that acquires a head temperature signal corresponding to a temperature of the print head at predetermined sampling periods and outputs a temperature information signal corresponding to the acquired head temperature signal, and a processor that controls the print head and the drive circuit. The print head includes a piezoelectric element that includes a first electrode, a second electrode, and a piezoelectric body located between the first electrode and the second electrode in a stacking direction in which the first electrode, the second electrode, and the piezoelectric body are stacked, and that receives the drive signal and is driven in response to the drive signal, a vibration plate that is located on one side of the piezoelectric element in the stacking direction and is deformed by the driving of the piezoelectric element, a pressure chamber substrate that is located on one side of the vibration plate in the stacking direction and is provided with a pressure chamber in which the liquid is stored and that changes in volume due to the deformation of the vibration plate, a nozzle from which the liquid is ejected in accordance with the change in the volume of the pressure chamber, and a temperature detecting section that is located on the other side of the vibration plate in the stacking direction and outputs the head temperature signal corresponding to a temperature of the pressure chamber. The temperature information output circuit holds a plurality of pieces of temperature information obtained by acquiring the head temperature signal at each of the sampling periods. The processor acquires, as an adjustment temperature information group, the plurality of pieces of temperature information held in the temperature information output circuit, and determines, based on the acquired adjustment temperature information group, a number of samples of the pieces of temperature information to be used to generate the temperature information signal. The number of samples determined by the processor is stored in the temperature information output circuit.

In this liquid ejecting apparatus, since the temperature detecting section that outputs the head temperature signal corresponding to the temperature of the pressure chamber is located in the vicinity of the pressure chamber, it is possible to accurately detect the temperature of the liquid stored in the pressure chamber.

In addition, in this liquid ejecting apparatus, the temperature information output circuit holds the plurality of pieces of temperature information obtained by acquiring the head temperature signal at each of the sampling periods, and the processor acquires the plurality of pieces of temperature information held in the temperature information output circuit as the adjustment temperature information group and determines, based on the acquired adjustment temperature information group, the number of samples of the pieces of temperature information to be used to generate the temperature information signal. The number of samples determined by the processor is stored in the temperature information output circuit. That is, the processor determines the optimum number of samples of the pieces of temperature information to be used to generate the temperature information signal, based on all of the plurality of pieces of temperature information which can be held in the temperature information output circuit. Therefore, it is possible to determine the optimum number of samples without requiring new manpower and equipment. That is, in the liquid ejecting apparatus according to the present embodiment, it is possible to improve the accuracy of detecting the temperature of the print head with a simple configuration without requiring new equipment and manpower.

In an aspect, in the liquid ejecting apparatus, the processor may determine the number of samples based on a difference between a maximum value and a minimum value of the temperature of the pressure chamber corresponding to each of the plurality of pieces of temperature information included in the adjustment temperature information group.

In an aspect, in the liquid ejecting apparatus, in a temperature comparison process of comparing the difference between the maximum value and the minimum value of the temperature of the pressure chamber corresponding to each of the plurality of pieces of temperature information included in the adjustment temperature information group with a predetermined threshold, the processor determines, as the number of samples, a number of the plurality of pieces of temperature information included in the adjustment temperature information group when the difference between the maximum value and the minimum value of the temperature of the pressure chamber corresponding to each of the plurality of pieces of temperature information included in the adjustment temperature information group is less than the predetermined threshold, and the processor discards, from the adjustment temperature information group, a piece of temperature information acquired earliest among the plurality of pieces of temperature information included in the adjustment temperature information group and executes the temperature comparison process again when the difference between the maximum value and the minimum value of the temperature of the pressure chamber corresponding to each of the plurality of pieces of temperature information included in the adjustment temperature information group is greater than or equal to the predetermined threshold.

In this liquid ejecting apparatus, it is possible to determine the number of samples in a range in which noise or the like caused by the propagation of the drive signal to the piezoelectric element, the deformation of the vibration plate, and an instantaneous change in the temperature of the ink stored in the pressure chamber is unlikely to have an effect, and it is possible to improve the accuracy of detecting the temperature of the print head calculated based on the number of samples.

In an aspect, in the liquid ejecting apparatus, when the number of the plurality of pieces of temperature information included in the adjustment temperature information group is less than or equal to two in the temperature comparison process, the processor may end the temperature comparison process and notify abnormality information.

In an aspect, in the liquid ejecting apparatus, at an output timing of outputting the temperature information signal, the temperature information output circuit may select the same number of pieces of temperature information as the number of samples in an order in which a timing at which a piece of temperature information among the plurality of pieces of temperature information is acquired and that is closest to the output timing, and may output the temperature information signal generated using the selected piece of temperature information.

In this liquid ejecting apparatus, since it is possible to calculate the temperature of the print head based on the number of samples determined in a range in which noise or the like caused by the propagation of the drive signal to the piezoelectric element, the displacement of the vibration plate, and an instantaneous change in the temperature of the ink stored in the pressure chamber is unlikely to have an effect, it is possible to improve the accuracy of detecting the temperature of the print head.

In an aspect, in the liquid ejecting apparatus, the drive circuit may output the drive signal corrected based on the temperature information signal.

In this liquid ejecting apparatus, since the accuracy of detecting the temperature of the print head is improved, the accuracy of the waveform of the drive signal corrected based on the temperature of the print head is improved. As a result, the accuracy of ejecting the ink based on the drive signal is also improved.

In an aspect, in the liquid ejecting apparatus, the temperature information output circuit may include an amplifier circuit that outputs an amplified head temperature signal obtained by amplifying the head temperature signal, and an A/D converter that acquires the amplified head temperature signal at each of the sampling periods and converts the amplified head temperature signal into the pieces of temperature information.

In an aspect, a head unit includes a print head that receives a drive signal and ejects liquid in response to the drive signal, and a temperature information output circuit that acquires a head temperature signal corresponding to a temperature of the print head at predetermined sampling periods and outputs a temperature information signal corresponding to the acquired head temperature signal. The print head includes a piezoelectric element that includes a first electrode, a second electrode, and a piezoelectric body located between the first electrode and the second electrode in a stacking direction in which the first electrode, the second electrode, and the piezoelectric body are stacked, and that receives the drive signal and is driven in response to the drive signal, a vibration plate that is located on one side of the piezoelectric element in the stacking direction and is deformed by the driving of the piezoelectric element, a pressure chamber substrate that is located on one side of the vibration plate in the stacking direction and is provided with a pressure chamber in which the liquid is stored and that changes in volume due to the deformation of the vibration plate, a nozzle from which the liquid is ejected in accordance with the change in the volume of the pressure chamber, and a temperature detecting section that is located on the other side of the vibration plate in the stacking direction and outputs the head temperature signal corresponding to a temperature of the pressure chamber. The temperature information output circuit stores a number of samples determined based on a plurality of pieces of temperature information obtained by acquiring the head temperature signal at each of the sampling periods.

In this head unit, since the temperature detecting section that outputs the head temperature signal corresponding to the temperature of the pressure chamber is located in the vicinity of the pressure chamber, it is possible to accurately detect the temperature of the liquid stored in the pressure chamber.

In addition, in this head unit, the temperature information output circuit calculates the temperature of the print head based on the number of samples of the pieces of temperature information that has been determined based on all of the plurality of pieces of temperature information obtained by acquiring the head temperature signal at each of the sampling periods and is to be used to generate the determined temperature information signal, and thus it is possible to improve the accuracy of detecting the temperature of the print head.

In an aspect, in the head unit, the number of samples may be determined based on a difference between a maximum value and a minimum value of the temperature of the pressure chamber corresponding to each of the plurality of pieces of temperature information.

In an aspect, in the head unit, in a temperature comparison process of comparing the difference between the maximum value and the minimum value of the temperature of the pressure chamber corresponding to each of the plurality of pieces of temperature information with a predetermined threshold, when the difference between the maximum value and the minimum value of the temperature of the pressure chamber corresponding to each of the plurality of pieces of temperature information is less than the predetermined threshold, a number of the plurality of pieces of temperature information may be determined as the number of samples, and when the difference between the maximum value and the minimum value of the temperature of the pressure chamber corresponding to each of the plurality of pieces of temperature information is greater than or equal to the predetermined threshold, a piece of temperature information acquired earliest among the plurality of pieces of temperature information may be discarded and the temperature comparison process may be executed again to determine the number of samples.

In this head unit, since the stored number of samples is within a range in which noise or the like caused by the propagation of the drive signal to the piezoelectric element, the deformation of the vibration plate, and an instantaneous change in the temperature of the ink stored in the pressure chamber is unlikely to have an effect, it is possible to improve the accuracy of detecting the temperature of the print head calculated based on the number of samples.

In an aspect, in the head unit, at an output timing of outputting the temperature information signal, the temperature information output circuit may select the same number of pieces of temperature information as the number of samples in an order in which a timing at which a piece of temperature information among the plurality of pieces of temperature information is acquired is closest to the output timing, and may output the temperature information signal generated using the selected piece of temperature information.

In this head unit, since it is possible to calculate the temperature of the print head based on the number of samples determined in a range in which noise or the like caused by the propagation of the drive signal to the piezoelectric element, the displacement of the vibration plate, and an instantaneous change in the temperature of the ink stored in the pressure chamber is unlikely to have an effect, it is possible to improve the accuracy of detecting the temperature of the print head.

In an aspect, in the head unit, the drive signal may be corrected based on the temperature information signal.

In this head unit, since the accuracy of detecting the temperature of the print head is improved, the accuracy of the waveform of the drive signal corrected based on the temperature of the print head is also improved, and the accuracy of ejecting the ink based on the drive signal is also improved.

In an aspect, in the head unit, the temperature information output circuit may include an amplifier circuit that outputs an amplified head temperature signal obtained by amplifying the head temperature signal, and an A/D converter that acquires the amplified head temperature signal at each of the sampling periods and converts the amplified head temperature signal into the pieces of temperature information.

What is claimed is:

1. A liquid ejecting apparatus comprising:
a drive circuit that outputs a drive signal;
a print head that receives the drive signal and ejects liquid in response to the drive signal;
a temperature information output circuit that acquires a head temperature signal corresponding to a temperature of the print head at predetermined sampling periods and outputs a temperature information signal corresponding to the acquired head temperature signal; and
a processor that controls the print head and the drive circuit, wherein
the print head includes
a piezoelectric element that includes a first electrode, a second electrode, and a piezoelectric body located between the first electrode and the second electrode in a stacking direction in which the first electrode, the second electrode, and the piezoelectric body are stacked, and that receives the drive signal and is driven in response to the drive signal,
a vibration plate that is located on one side of the piezoelectric element in the stacking direction and is deformed by the driving of the piezoelectric element,
a pressure chamber substrate that is located on one side of the vibration plate in the stacking direction and is provided with a pressure chamber in which the liquid is stored and that changes in volume due to the deformation of the vibration plate,
a nozzle from which the liquid is ejected in accordance with the change in the volume of the pressure chamber, and
a temperature detecting section that is located on the other side of the vibration plate in the stacking direction and outputs the head temperature signal corresponding to the temperature of the pressure chamber,
the temperature information output circuit holds a plurality of pieces of temperature information obtained by acquiring the head temperature signal at each of the sampling periods,
the processor acquires, as an adjustment temperature information group, the plurality of pieces of temperature information held in the temperature information output circuit, and determines, based on the acquired adjustment temperature information group, a number of samples of the pieces of temperature information to be used to generate the temperature information signal, and
the number of samples determined by the processor is stored in the temperature information output circuit.

2. The liquid ejecting apparatus according to claim 1, wherein
the processor determines the number of samples based on a difference between a maximum value and a minimum value of the temperature of the pressure chamber corresponding to each of the plurality of pieces of temperature information included in the adjustment temperature information group.

3. The liquid ejecting apparatus according to claim 2, wherein
in a temperature comparison process of comparing the difference between the maximum value and the minimum value of the temperature of the pressure chamber corresponding to each of the plurality of pieces of temperature information included in the adjustment temperature information group with a predetermined threshold,
when the difference between the maximum value and the minimum value of the temperature of the pressure chamber corresponding to each of the plurality of pieces of temperature information included in the adjustment temperature information group is less than the predetermined threshold, the processor determines, as the number of samples, a number of the plurality of pieces of temperature information included in the adjustment temperature information group, and
when the difference between the maximum value and the minimum value of the temperature of the pressure chamber corresponding to each of the plurality of pieces of temperature information included in the adjustment temperature information group is greater than or equal to the predetermined threshold, the processor discards, from the adjustment temperature information group, a piece of temperature information acquired earliest among the plurality of pieces of temperature information included in the adjustment temperature information group, and executes the temperature comparison process again.

4. The liquid ejecting apparatus according to claim 3, wherein
when the number of the plurality of pieces of temperature information included in the adjustment temperature information group is less than or equal to two in the temperature comparison process, the processor ends the temperature comparison process and notifies abnormality information.

5. The liquid ejecting apparatus according to claim 1, wherein
at an output timing of outputting the temperature information signal, the temperature information output circuit selects the same number of pieces of temperature information as the number of samples in an order in which a timing at which a piece of temperature information among the plurality of pieces of temperature information is acquired is closest to the output timing, and outputs the temperature information signal generated using the selected piece of temperature information.

6. The liquid ejecting apparatus according to claim 1, wherein
the drive circuit outputs the drive signal corrected based on the temperature information signal.

7. The liquid ejecting apparatus according to claim 1, wherein
the temperature information output circuit includes
an amplifier circuit that outputs an amplified head temperature signal obtained by amplifying the head temperature signal, and
an A/D converter that acquires the amplified head temperature signal at each of the sampling periods and converts the amplified head temperature signal into the pieces of temperature information.

8. A head unit comprising:
a print head that receives a drive signal and ejects liquid in response to the drive signal; and
a temperature information output circuit that acquires a head temperature signal corresponding to a temperature of the print head at predetermined sampling periods and outputs a temperature information signal corresponding to the acquired head temperature signal, wherein
the print head includes
a piezoelectric element that includes a first electrode, a second electrode, and a piezoelectric body located between the first electrode and the second electrode in a stacking direction in which the first electrode, the second electrode, and the piezoelectric body are stacked, and that receives the drive signal and is driven in response to the drive signal,
a vibration plate that is located on one side of the piezoelectric element in the stacking direction and is deformed by the driving of the piezoelectric element,
a pressure chamber substrate that is located on one side of the vibration plate in the stacking direction and is provided with a pressure chamber in which the liquid is stored and that changes in volume due to the deformation of the vibration plate,
a nozzle from which the liquid is ejected in accordance with the change in the volume of the pressure chamber, and
a temperature detecting section that is located on the other side of the vibration plate in the stacking direction and outputs the head temperature signal corresponding to the temperature of the pressure chamber, and
the temperature information output circuit stores a number of samples determined based on a plurality of pieces of temperature information obtained by acquiring the head temperature signal at each of the sampling periods.

9. The head unit according to claim 8, wherein
the number of samples is determined based on a difference between a maximum value and a minimum value of the temperature of the pressure chamber corresponding to each of the plurality of pieces of temperature information.

10. The head unit according to claim 9, wherein
in a temperature comparison process of comparing the difference between the maximum value and the minimum value of the temperature of the pressure chamber corresponding to each of the plurality of pieces of temperature information with a predetermined threshold,
when the difference between the maximum value and the minimum value of the temperature of the pressure chamber corresponding to each of the plurality of pieces of temperature information is less than the predetermined threshold, a number of the plurality of pieces of temperature information is determined as the number of samples, and
when the difference between the maximum value and the minimum value of the temperature of the pressure chamber corresponding to each of the plurality of pieces of temperature information is greater than or equal to the predetermined threshold, a piece of temperature information acquired earliest among the plurality of pieces of temperature information is discarded and the temperature comparison process is executed again to determine the number of samples.

11. The head unit according to claim 8, wherein
at an output timing of outputting the temperature information signal, the temperature information output circuit selects the same number of pieces of temperature information as the number of samples in an order in which a timing at which a piece of temperature information among the plurality of pieces of temperature information is acquired is closest to the output timing, and outputs the temperature information signal generated using the selected piece of temperature information.

12. The head unit according to claim 8, wherein
the drive signal is corrected based on the temperature information signal.

13. The head unit according to claim 8, wherein
the temperature information output circuit includes
an amplifier circuit that outputs an amplified head temperature signal obtained by amplifying the head temperature signal, and
an A/D converter that acquires the amplified head temperature signal at each of the sampling periods and converts the amplified head temperature signal into the pieces of temperature information.
